(19) United States
(12) Patent Application Publication
(10) Pub. No.: US 2014/0275351 A1
(43) Pub. Date: Sep. 18, 2014

(54) HYDROPHOBIZING AGENTS FOR USE IN MAKING COMPOSITE LIGNOCELLULOSE PRODUCTS

(71) Applicant: Georgia-Pacific Chemicals LLC, Atlanta, GA (US)

(72) Inventors: Jeffrey Balogh, Covington, GA (US); Kim Tutin, East Point, GA (US); David F. Townsend, Grayson, GA (US)

(73) Assignee: Georgia-Pacific Chemicals LLC, Atlanta, GA (US)

(21) Appl. No.: 14/203,785

(22) Filed: Mar. 11, 2014

Related U.S. Application Data
(60) Provisional application No. 61/782,350, filed on Mar. 14, 2013.

(51) Int. Cl. C08L 97/02

(52) U.S. Cl. CPC C08L 97/02
USPC 524/14; 524/13

(57) ABSTRACT

Hydrophobizing agents for use in making composite lignocellulose products are provided. In at least one specific embodiment, a method for making a composite product can include contacting a plurality of lignocellulosic substrates with a resin and a hydrophobizing agent to form a mixture. The hydrophobizing agent can include one or more vegetable waxes, one or more alkaline metal alkylsiliconates, one or more alkyl ketene dimers, one or more organosilanes, one or polysiloxanes, one or more Fischer-Tropsch waxes, one or more fluorinated polyurethanes, one or more fluorinated acrylate polymers, one or more olefin metathesis products, or any mixture thereof. The method can also include at least partially curing the mixture to produce a composite product.

### CROSS-REFERENCE TO RELATED APPLICATION

This application claims priority to U.S. Provisional Patent Application having Ser. No. 61/782,350, filed Mar. 14, 2013, which is incorporated by reference herein.

### BACKGROUND

1. Field

Embodiments described generally relate to hydrophobizing agents for use in making composite lignocellulose products. More particularly, such embodiments relate to non-petroleum based hydrophobizing agents for use in making composite lignocellulose products.

2. Description of the Related Art

Petroleum based waxes or hydrophobizing agents such as slack wax, are key ingredients used to impart hydrophobicity to composite lignocellulose products, e.g., flakeboard, waferboard, and particle board, to reduce water uptake and swelling. Slack wax is a byproduct of oil refining and lube production. Petroleum based waxes such as slack wax exhibit natural variability in the wax composition and properties, which translates into variability in the properties of composite lignocellulose products made with these petroleum based waxes. Reducing or eliminating the variability in the final product's properties due to the use of petroleum based waxes could improve the consistency and overall properties of the composite lignocellulose products.

There is a need, therefore, for improved hydrophobizing agents for use in the production of composite lignocellulose products.

### SUMMARY

Hydrophobizing agents for use in making composite lignocellulose products are provided. In at least one specific embodiment, a method for making a composite product can include contacting a plurality of lignocellulosic substrates with a resin and a hydrophobizing agent to form a mixture. The hydrophobizing agent include one or more vegetable waxes, one or more alkaline metal alkylsiliconates, one or more alkyl ketene dimers, one or more organosilanes, one or polysiloxanes, one or more Fischer-Tropsch waxes, one or more fluorinated polyurethanes, one or more fluorinated acrylate polymers, one or more olefin metathesis products, or any mixture thereof. The method can also include at least partially curing the mixture to produce a composite product.

In at least one specific embodiment, a resinated furnish can include a plurality of lignocellulosic substrates, a resin, and a hydrophobizing agent. The hydrophobizing agent can include one or more vegetable waxes, one or more alkaline metal alkylsiliconates, one or more alkyl ketene dimers, one or more organosilanes, one or polysiloxanes, one or more Fischer-Tropsch waxes, one or more fluorinated polyurethanes, one or more fluorinated acrylate polymers, one or more olefin metathesis products, or any mixture thereof.

In at least one specific embodiment, a method for making a composite product can include contacting a plurality of lignocellulosic substrates with a resin and a hydrophobizing agent to form a mixture. The hydrophobizing agent can include a hydrogenated metathesis product. The method can also include at least partially curing the mixture to produce a composite product.

### DETAILED DESCRIPTION

The hydrophobizing agent can impart increased or comparable moisture resistance to lignocellulose composite products made using the hydrophobizing agent as compared to a comparative lignocellulose composite product made the same way, but with slack wax. The hydrophobizing agent can also have a synergistic effect with the binder composition. For example, it has been surprisingly and unexpectedly discovered that the hydrophobizing agent can increase the tack of the resin, increase the water resistance of the composite lignocellulose product or simply “composite product,” increase the internal bond strength of the composite product, and/or decrease the thickness swell of the composite product.

The hydrophobizing agent can be or include one or more non-petroleum based hydrophobizing agents. Said another way, the hydrophobizing agent can be made from one or more compounds that are not extracted or otherwise recovered from petroleum. In other words, the hydrophobizing agent can be synthesized, separated, or otherwise derived from one or more non-petroleum reactants or sources. The hydrophobizing agent can include, but is not limited to, one or more vegetable waxes, one or more alkaline metal alkylsiliconates, one or more alkyl ketene dimers (AKD), one or more organosilanes, one or more silicones and/or polysiloxanes, one or more Fischer-Tropsch waxes, one or more fluorinated polyurethanes, one or more fluorinated acrylate polymers, one or more olefin metathesis products, or any combination or mixture thereof.

The hydrophobizing agent can be substantially free from any petroleum based hydrophobizing agent. For example, the hydrophobizing agent can contain less than 5 wt %, less than 4 wt %, less than 3.5 wt %, less than 3 wt %, less than 2.5 wt %, less than 2 wt %, less than 1.5 less than, less than 1 wt %, less than 0.7 wt %, less than 0.5 wt %, less than 0.3 wt %, or less than 0.1 wt %, based on the amount of the hydrophobizing agent. In at least one specific embodiment, the hydrophobizing agent can be free from any petroleum based hydrophobizing agent.

The hydrophobizing agent can be or include a mixture of two or more hydrophobizing agents. If the hydrophobizing agent includes two or more hydrophobizing agents, each hydrophobizing agent can be present in the same concentration or different concentration with respect to one another. For example, a first hydrophobizing agent can be present in a weight ratio of about 99:1, about 90:10, about 80:20, about 70:30, about 60:40, about 50:50, about 40:60, about 30:70, about 20:80, about 10:90, or about 1:99 with respect to another or “second” hydrophobizing agent contained therein. Similarly, if three or more hydrophobizing agents are mixed, the three or more hydrophobizing agents can be present in any ratio.

If two or more hydrophobizing agents are combined with one another, the two or more hydrophobizing agents can be heated above their respective melting points and liquefied so they can be introduced in a mixing tank or vessel. The hydrophobizing agents can be agitated for a period of time to achieve a homogeneous mixture. Mixing blades or shear agitation can be used to mix the hydrophobizing agents. In-line mixing through a mixing tube can, for example, also be used to product a multi-component hydrophobizing agent.

High pressing temperatures utilized in the fabrication of composite products can present a risk of fire hazards. As such, a hydrophobizing agent having a flash point greater than the pressing temperature utilized in the fabrication of the composite product can be selected to reduce the risk of fire. For example, the pressing temperature of oriented strand board (OSB) can be about 232° C. and a hydrophobizing agent having a flash point above 232° C. can be selected to reduce the risk of fire. In another example, the hydrophobizing agent can have a flash point from a low of about 120° C., about 130° C., about 140° C., about 150° C., or about 200° C. to a high of about 280° C., about 300° C., about 310° C., about 330° C., or about 350° C. or more. For example, the hydrophobizing agent can also have a flash point of about 122° C. to about 142° C., about 139° C. to about 166° C., about 164° C. to about 205° C., about 200° C. to about 230° C., about 220° C. to about 250° C., about 248° C. to about 270° C., about 263° C. to about 301° C., about 274° C. to about 297° C., or about 294° C. to about 318° C.

The hydrophobizing agent can be used neat, such as in powder form and/or in a liquid form, or it can be mixed, blended, or otherwise combined with one or more liquid mediums. Illustrative liquid mediums can include, but are not limited to, water, alcohols, glycols, acetonitrile, dimethyl sulfoxide, N,N-dimethylformamide, N-methylpyrrolidone, or any combination thereof. Suitable alcohols can include, but are not limited to, methanol, ethanol, propanol, isopropanol, butanol, any combination thereof, or any mixture thereof. Suitable glycols can include, but are not limited to, ethylene glycol, propylene glycol, or a combination thereof. As used herein, the terms “aqueous medium” and “aqueous liquid” can be or include water and/or mixtures composed of water and/or other water-miscible solvents. Illustrative water-miscible solvents can include, but are not limited to, alcohols, ethers, amines, other polar aprotic solvents, and the like.

The mixture of the hydrophobizing agent and liquid medium can have a hydrophobizing agent concentration from a low of about 0.6 wt %, about 1 wt %, about 4 wt %, about 6 wt %, about 9 wt %, or about 12 wt % to a high of about 18 wt %, about 22 wt %, about 26 wt %, about 29 wt %, or about 35 wt %, based on the combined weight of the hydrophobizing agent and the liquid medium. For example, the mixture of the hydrophobizing agent and the liquid medium can have a hydrophobizing agent concentration of about 0.8 wt % to about 3 wt %, about 5 wt % to about 8 wt %, about 9 wt % to about 13 wt %, about 14 wt % to about 17 wt %, about 19 wt % to about 25 wt %, or about 25 wt % to about 30 wt %, based on the combined weight of the hydrophobizing agent and the liquid medium.

The mixture of the hydrophobizing agent and the liquid medium can have a liquid medium concentration from a low of about 55 wt %, about 60 wt %, or about 65 wt % to a high about 85 wt %, about 95 wt %, or about 99.9 wt %, based on the combined weight of the hydrophobizing agent and the liquid medium. In another example, the mixture of the hydrophobizing agent and the liquid medium can also have a liquid medium concentration of about 20 wt % to about 40 wt %, about 40 wt % to about 60 wt %, about 60 wt % to about 80 wt %, about 80 wt % to about 95 wt %, about 25 wt % to about 75 wt %, about 60 wt % to about 90 wt %, or about 75 wt % to about 85 wt %, based on the combined weight of the hydrophobizing agent and the liquid medium. In another example, the mixture of hydrophobizing agent can have a liquid medium content of at least 80 wt %, at least 82 wt %, at least 84 wt %, at least 86 wt %, at least 88 wt %, or at least 90 wt %, based on the combined weight of the hydrophobizing agent and the liquid medium.

The mixture of hydrophobizing agent and liquid medium can have a solids content from a low of about 20 wt %, about 40 wt %, about 50 wt %, or about 65 wt % to a high of about 75 wt %, about 80 wt %, about 85 wt %, or about 95 wt %, based on the combined weight of the hydrophobizing agent and the liquid medium. In another example, the mixture of hydrophobizing agent and liquid medium can have a solids content of about 20 wt % to about 40 wt %, about 40 wt % to about 60 wt %, about 60 wt % to about 80 wt %, about 80 wt % to about 95 wt %, about 25 wt % to about 75 wt %, about 60 wt % to about 90 wt %, or about 75 wt % to about 85 wt %, based on the combined weight of the hydrophobizing agent and the liquid medium. In another example, the mixture of hydrophobizing agent and liquid medium can have a solids content of at least 80 wt %, at least 82 wt %, at least 84 wt %, at least 86 wt %, at least 88 wt %, or at least 90 wt %, based on the combined weight of the hydrophobizing agent and the liquid medium. As used herein, the solids content of the liquid medium, as understood by those skilled in the art, can be measured by determining the weight loss upon heating a small sample, e.g., about 1 gram to about 5 grams of the mixture of hydrophobizing agent, to a suitable temperature, e.g., about 125° C., and a time sufficient to remove the liquid therefrom.

The components of the mixture of the hydrophobizing agent and the liquid medium can be combined simultaneously or in any order or sequence with respect to one another. The mixture of the hydrophobizing agent and the liquid medium can be in the form of a solution, a suspension, an emulsion, and/or a dispersion. The mixture of the hydrophobizing agent and the liquid medium can be mixed, emulsified, suspended and/or dispersed with a homogenizer or a sonicator. The shear forces can emulsify the mixture and reduce the particle size of the emulsion. The hydrophobizing agent can have a mean particle size of at least 50 nm, at least 100 nm, at least 150 nm, at least 250 nm, at least 400 nm, at least 500 nm, at least 700 MI, at least 850 nm, or at least 1,000 nm. The hydrophobizing agent can have a mean particle size of less than 600 nm, less than 500 nm or less than 410. For example, the hydrophobizing agent can have a mean particle size from a low of about 25 nm, about 50 nm, about 75 nm or about 90 nm to a high of about 200 nm, about 300 nm, about 2,000 nm, about 3,000 nm, about 4,000 nm, or about 5,000 nm. In another example, the hydrophobizing agent can have a mean particle size of about 30 nm to about 55 nm, about 66 nm to about 110 nm, about 50 nm to about 300 nm, about 100 nm to about 169 nm, about 149 nm to about 210 nm, about 200 nm to about 400 nm, about 1,005 nm to about 1,755 nm, or about 2,200 nm to about 4,855 nm.

The hydrophobizing agent and the liquid medium can be mixed at temperature from a low of about 10° C., about 20° C., about 30° C., about 40° C., about 50° C. to a high of about 80° C., about 100° C., about 120° C., about 140° C., or about 160° C. In another example, the hydrophobizing agent and the liquid medium can be mixed at temperature of about 15° C. to about 35° C., about 25° C. to about 55° C., about 65° C. to about 85° C., about 80° C. to about 95° C., about 105° C. to about 115° C., about 100° C. to about 125° C., or about 135° C. to about 155° C.

The mixture of the hydrophobizing agent and the liquid medium can include one or more surfactants to aid in the emulsification. Illustrative surfactants can include, but are not limited to, dioctyldimethylammonium chloride, didecyldimethylammonium chloride, dicocodimethylammonium chloride, cocobenzyldimethylammonium chloride, coco(fractionated)benzyldimethylammonium chloride, octadecyl trimethylammonium chloride, dioctadecyl dimethylammonium chloride, dihexadecyl dimethylammonium chloride, di(hydrogenated tallow)dimethylammonium chloride, di(hydrogenated tallow)benzylmethylammonium chloride, (hydrogenated tallow)benzyldimethylammonium chloride, dioleyldimethylammonium chloride, and di(ethylene hexadecanecarboxylate)dimethylammonium chloride, alkylphenol, ethoxilated, ethoxilated fatty acids, ethoxylated fatty alcohols, salts of fatty acids, ethylene oxide-propylene oxide block copolymers, and mixtures thereof. The amount of the surfactant that can be combined or mixed with the hydrophobizing agent and the liquid medium can be from a low of about 0.1 wt %, about 0.5 wt %, about 1 wt %, about 1.5 wt %, about 2 wt %, about 3 wt %, about 4 wt %, about 5 wt %, or about 7 wt % to a high of about 10 wt %, about 12 wt %, about 15 wt %, about 18 wt %, or about 20 wt %, based on the combined weight of the hydrophobizing agent, the surfactant, and the liquid medium.

The mixture of the hydrophobizing agent and the liquid medium can include one or more dispersants. The dispersant can include non-surface active substances or surface-active substances added to improve the separation of particles and/or to inhibit settling or clumping. The dispersants can be cationic, anionic, non-ionic, or amphoteric. The dispersants can include natural starches and derivatized starches. Suitable starch dispersants can include, but are not limited to, hydroxyethyl-, hydroxypropyl-, methyldroxypropyl-, and ethylhydroxyethylcellulose, methyl- and carboxymethylcellulose, gelatin, starch, guar gum, xanthan gum, polyvinyl alcohol, and mixtures thereof. Derivatized starches can be obtained by reacting natural starches with cationizing agents, such as glycidyltrimethylammonium chloride or 3-chloro-2-hydroxypropyltrimethylammonium chloride. Non-ionic dispersants can include, but are not limited to, ethoxylated fatty alcohols, fatty acids, alkyl phenols, fatty acid amides, ethoxylated or non-ethoxylated glycerol esters, sorbitan esters of fatty acids, and mixtures thereof. Suitable cationic dispersants can include nitrogen-containing compounds such as quaternary ammonium compounds, salts of tertiary amines, water-soluble nitrogen-containing epichlorohydrin resins, cationic polyurethanes, polyamideamines, polyamideamine-epichlorohydrin copolymers, dimethylamine-epichlorohydrin copolymers, dimethylamine-ethylenediamine-epichlorohydrin copolymers, ammonia-ethylenendichloride copolymers, homopolymers and copolymers of diallyldimethylammonium chloride, dialkyl-aminoalkyl acrylates, methacrylates and acrylamides (e.g., dimethylaminoethyl acrylates and methacrylates), cationic polymers (e.g., polyacrylamide, polyethyleneimine, polyamidoamine and poly(diallyldimethyl ammoniumchloride)) and mixtures thereof. Suitable anionic dispersants can include, but are not limited to, phosphated, sulfonated and carboxylated lignin or polysaccharides, anionic polyurethanes, naphthalene sulfonates, and vinyl addition polymers formed from monomers with anionic groups (e.g., acrylic acid, methacylic acid, maleic acid, itaconic acid, crotonic acid, vinylsulfonic acid, sulfonated styrene and phosphates of hydroxyalkyl acrylates, and methacrylates). The amount of the dispersant that can be combined or mixed with the hydrophobizing agent and the liquid medium can be from a low of about 0.1 wt %, about 0.5 wt %, about 1 wt %, about 2 wt %, about 3 wt %, about 4 wt %, about 5 wt %, about 6 wt %, or about 7 wt %, to a high of about 10 wt %, about 15 wt %, about 18 wt %, or about 20 wt %, based on the combined weight of the hydrophobizing agent, the dispersant, and the liquid medium.

The mixture of the hydrophobizing agent and the liquid medium can include one or more include inorganic bases or base compounds. Illustrative inorganic bases can include, but are not limited to, potassium hydroxide, sodium hydroxide, calcium hydroxide, magnesium hydroxide, or any mixture thereof. The amount of the inorganic base that can be combined or mixed with the hydrophobizing agent and the liquid medium can be from a low of about 0.1 wt %, about 0.3 wt %, about 0.5 wt %, about 0.8 wt %, or about 1 wt % to a high of about 2 wt %, about 3 wt %, about 4 wt %, about 5 wt %, or about 6 wt %, based on the combined weight of the hydrophobizing agent, the inorganic base, and the liquid medium. For example, the inorganic base can be present in an amount of about 0.2 wt % to about 0.4 wt %, about 0.5 wt % to about 0.7 wt %, about 1.0 wt % to about 1.6 wt %, about 2.4 wt % to about 3.7 wt %, or about 4.2 wt % to about 5.8 wt %, based on the combined weight of the hydrophobizing agent, the inorganic base, and the liquid medium.

The mixture of the hydrophobizing agent and the liquid medium can include one or more acids. Illustrative acids can include, but are not limited to, hydrochloric acid, sulfuric acid, phosphoric acid, any combination thereof, or any mixture thereof. The amount of the acid that can be combined or mixed with the hydrophobizing agent and the liquid medium can be from a low of about 0.1 wt %, about 0.3 wt %, about 0.5 wt %, about 0.8 wt %, or about wt % to a high of about 2 wt %, about 3 wt %, about 4 wt %, about 5 wt %, or about 6 wt %, based on the combined weight of the hydrophobizing agent, the acid, and the liquid medium. For example, the acid can be present in an amount of about 0.2 wt % to about 0.4 wt %, about 0.5 wt % to about 0.7 wt %, about 1.0 wt % to about 1.6 wt %, about 2.4 wt % to about 3.7 wt %, or about 4.2 wt % to about 5.8 wt %, based on the combined weight of the hydrophobizing agent, the acid, and the liquid medium.

The pH of the mixture of the hydrophobizing agent and the liquid medium can be from a low of about 1, about 2, about 3, about 4, about 5, about 6, about 7 to a high of about 8, about 9, about 10, about 11, about 12, or about 13. In another example, the mixture of the hydrophobizing agent and the liquid medium can have a pH of about 1 to about 2, about 2 to about 3, about 3 to about 4, about 4 to about 5, about 5 to about 6, about 6 to about 7, about 7 to about 8, about 8 to about 9, about 9 to about 10, about 10 to about 11, about 11 to about 12, about 12 to about 13, about 1 to about 6.5, about 3 to about 6, about 2 to about 5, about 7 to about 9, about 7.5 to about 12, about 8.5 to about 11, or about 5 to about 9.

The mixture of the hydrophobizing agent and the liquid medium can include one or more other additives. For example, the mixture of the hydrophobizing agent and the liquid medium can include one or more anti-oxidants, corrosion inhibitors, dyes, fungicides, insecticides, or any combination thereof. An illustrative anti-oxidant can include tert-butylhydroquinone (TBHQ). The amount of the additive that can be combined or mixed with the hydrophobizing agent and the liquid medium can be from a low of about 0.1 wt %, about 0.3 wt %, about 0.5 wt %, about 0.7 wt %, about 1 wt %, about 2 wt %, about 3 wt %, about 4 wt %, about 5 wt %, about 6 wt %, or about 7 wt %, to a high of about 10 wt %, about 15 wt %, about 18 wt %, or about 20 wt %, based on the combined weight of the hydrophobizing agent, the additive, and the liquid medium.

Illustrative vegetable waxes can include but are not limited to, carnauba wax, bayberry wax, candelilla wax, ouricury wax, or any mixture thereof. Carnauba wax is a protective coating for leaves that can be harvested from Copernica cerifera, a Brazilian palm tree. Carnauba is a hard, brittle wax with a melting point of 86° C.

The vegetable wax can be made from vegetable oils. After harvesting, the vegetable matter can be cleaned, cracked, de-hulled, and rolled into flakes. An oil can be then extracted from the flakes and hydrogenated. The hydrogenation process converts some of the fatty acids in the oil from unsaturated to saturated. This process can increase the melting point of the oil, making it a solid at room temperature.

Illustrative vegetable oils can include, but are not limited to, safflower oil, grape seed oil, sunflower oil, walnut oil, soybean oil, cottonseed oil, coconut oil, corn oil, olive oil, palm oil, peanut oil, rapeseed oil, canola oil, sesame oil, hazelnut oil, almond oil, beech nut oil, cashew oil, macadamia oil, mongongo nut oil, pecan oil, pine nut oil, pistachio oil, grapefruit seed oil, lemon oil, orange oil, watermelon seed oil, bitter gourd oil, buffalo gourd oil, butternut squash seed oil, egusi seed oil, pumpkin seed oil, borage seed oil, blackcurrant seed oil, evening primrose oil, acai oil, black seed oil, flaxseed oil, carob pod oil, amaranth oil, apricot oil, apple seed oil, argan oil, avocado oil, babassu oil, ben oil, borneo tallow nut oil, cape chestnut, algaroba oil, cocoa butter, cocklebur oil, poppy seed oil, cohune oil, coriander seed oil, date seed oil, dika oil, false flax oil, hemp oil, kapok seed oil, kenaf seed oil, lallemantia oil, mafura oil, marula oil, meadowfoam seed oil, mustard oil, okra seed oil, papaya seed oil, perilla seed oil, persimmon seed oil, pequi oil, pili nut oil, pomegranate seed oil, prune kernel oil, quinoa oil, ramtil oil, rice bran oil, royle oil, shea nut oil, sacha inchi oil, sapote oil, seje oil, taramira oil, tea seed oil, thistle oil, tigernut oil, tobacco seed oil, tomato seed oil, wheat germ oil, castor oil, colza oil, flax oil, radish oil, salicornia oil, tung oil, honge oil, jatropha oil, jojoba oil, nahor oil, paradise oil, petroleum nut oil, dammar oil, linseed oil, stillingia oil, vernonia oil, amur cork tree fruit oil, artichoke oil, balanos oil, bladderpod oil, brucea javanica oil, burdock oil, candlenut oil, carrot seed oil, chaulmoogra oil, crambe oil, croton oil, cuphea oil, honesty oil, jojoba oil, mango oil, neem oil, oojon oil, rose hip seed oil, rubber seed oil, sea buckthorn oil, sea rocket seed oil, snowball seed oil, tall oil, tamanu oil, tonka bean oil, ucuhuba seed oil, or any mixture thereof.

The alkaline metal alkylsiliconates can include, but are not limited to, sodium methylsiliconate, sodium ethylsiliconate, sodium propylsiliconate, potassium methylsiliconate, potassium ethylsiliconate, potassium propylsiliconate, or any mixture thereof.

Illustrative alkyl ketene dimers can be represented by general Formula 1:

[chemical structure]

where R¹ and R² are independently a C₈- to C₃₀-hydrocarbon radical which can be saturated or unsaturated and linear or branched. For example, R¹ and R² can independently be an octyl, decyl, dodecyl, tetradecyl, hexadecyl, octadecyl, eicosyl, docosyl, tetracosyl, phenyl, benzyl, β-naphthyl, or cyclohexyl radical.

The compounds represented by Formula 1 can be prepared by reacting one or more carboxylic acid chlorides with one or more tertiary amines. The carboxylic acid chlorides can be obtained, for example, by chlorination of naturally occurring fatty acids or mixtures thereof. For example, carboxylic acid chlorides based on fatty acids can be obtained from coconut oil, tall oil, castor oil, olive oil, beef tallow, palm kernel oil, and the like. The carboxylic acid chlorides can include, but are not limited to, myristoyl chloride, palmitoyl chloride, stearoyl chloride, oleoyl chloride, behenoyl chloride, and isostearoyl chloride. Commercially available alkyl ketene dialer can include, but are not limited to, NOVASIZE® AKD™ 3016 available from Georgia Pacific Chemicals, LLC and AKD 1865 available from Kemira Tiancheng Chemicals Co., Ltd.

Suitable organosilanes can include those represented by general Formula 2:

[chemical structure]

where R¹, R², R³, and R⁴ can independently be hydroxyl radicals; C₁- to C₈ alkoxy radicals, which can be saturated or unsaturated and linear or branched; C₁- to C₈-hydrocarbon radicals, which can be saturated or unsaturated and linear or branched. For example, R¹, R², R³, and R⁴ can independently be a hydrogen, methyl, ethyl, propyl, pentyl, hexyl, heptyl, or octyl radicals. In another example R¹, R², R³, and R⁴ can independently be methoxy, ethoxy, or propoxy, pentoxy, hexoxy, heptoxy, or octoxy radicals. In yet another example, the organosilane can be triethoxyoctylsilane.

Suitable silicones or polysiloxanes can include those represented by general Formula 3.

[chemical structure]

where R¹ and R² can independently be hydroxyl radical, C₁- to C₄ alkoxy radicals that can be saturated or unsaturated and linear or branched, C₁- to C₆-hydrocarbon radicals that can be saturated or unsaturated and linear or branched. For example, R₁, and R₂ can independently be a hydrogen, methyl, ethyl, or propyl radical. In another example, R₁, and R₂ can independently be methoxy, ethoxy, or propoxy radical. The average polymer chain length n of the polysiloxanes can be 1 to about 6,000.

The silicones or polysiloxanes can include branched and/or linear siloxane polymer chains. The organic side chains can be used to crosslink two or more of the —Si—O— backbones together. By varying the —Si—O— chain lengths, side groups, and/or crosslinking, silicone polymers can be synthesized with a wide variety of properties and compositions.

Illustrative silicones or polysiloxanes can include, but is not limited to, poly(methyl hydrogen siloxane) and the types referred to in U.S. Pat. Nos. 3,455,710; 3,623,895; 4,136,687; 4,447,498; 4,643,771; and 5,135,805. On example, of this type of organopolysiloxane can be poly(methyl hydrogen siloxane).

The Fischer-Tropsch synthesis is a well-known synthetic process made up of collection of reactions for converting carbon monoxide and small alkanes, such as methane, to larger alkanes in presence of a metal catalyst. The metal catalyst can be cobalt, iron, ruthenium, and nickel-based catalysts. The catalyst can be supported on silica, alumina, or zeolites. The Fischer-Tropsch waxes derived from a Fischer-Tropsch synthesis can include, but are not limited to, straight and branched (C₁₅-C₄₅)alkanes. At least one commercially available Fischer-Tropsch wax can include Sasol 3145 and SASOLWAX® made by Sasol Limited of Rosebank, South Africa. It has been surprisingly and unexpectedly discovered that using Fischer-Tropsch waxes, which have a more consistent product distribution than conventional slack waxes, can facilitate production of composite lignocellulose products having more consistent, regular, and/or improved properties.

Suitable fluorochemical monomers used to synthesize the fluorinated polyurethanes can be represented by general Formula 4:

[chemical structure]

where M^{f}ₘM^{h}ₗ can be a fluorochemical spacer oligomer, that includes m units derived from a fluorochemical spacer monomer (M^{f}) and l units derived from one or more other polymerizable monomers (M^{h}) that can be fluorinated or fluorine-free, and where the fluorochemical spacer monomers and polymerizable monomers can be the same or different. m can be a number from 2 to 40, l can be a number from 0 to 20, T can be an organic linking group obtained by removing a hydrogen atom from a chain transfer agent, and the T residues can be the same or different with respect to one another, Z can be a residue obtained by removing a hydrogen atom from an isocyanate-reactive group or blocking group, and the Z residues can be the same or different with respect to one another, A and A′ can independently be a di-, tri-, or tetravalent residue obtained by removing 2, 3, or 4 —NCO groups from a corresponding isocyanate, and the A residues and A′ residues can be the same or different with respect to one another, B can be a divalent organic residue obtained by removing the two X—H groups from a difunctional active hydrogen compound HX—B—XH, where X can independently be O, NH, or S, and the B residues can be the same or different with respect to one another, a can be a number from 1 to 3, b can be a number from 0 to 2 with the proviso that a+b has a value from 1 to 3, c can be a number from 0 to 30, and d and e can be a number from 0 to 2 provided that d+e is not greater than 2.

The compounds represented by general Formula 4 are polyurethanes, e.g., the compound can include at least one polymeric portion within the compound that can be obtained by the reaction of an isocyanate group containing compounds with a chain extender having two isocyanate reactive X—H groups. The moiety derived from the chain extender can be represented in the Formula 4 by the residue —X—B—X—. These fluorochemical polyurethane compounds can exhibit a surprising ability to impart not only high initial oil- and water-repellency to treated substrates but also durable repellency.

The fluorinated polyurethanes can be prepared by reacting a fluorochemical spacer oligomer that includes the oligomerization product of fluorochemical spacer monomers alone or in combination with other polymerizable monomers that can be fluorinated or fluorine-free, in the presence of at least one functionalized chain transfer agent; a di-, tri-, or tetravalent isocyanate or combinations thereof; optionally, at least one blocking agent or isocyanate-reactive group; and, optionally, at least one multi-functional chain extender.

Suitable fluorinated polyurethanes can also be represented by general Formula 5:

[chemical structure]

where M^{f}ₘM^{h}ₗ can be a fluorochemical spacer oligomer, that includes m units derived from a fluorochemical spacer monomer, M^{f}, and l units derived from one or more other polymerizable monomers, M^{h}, that can be fluorinated or fluorine-free, where the fluorochemical spacer monomers and polymerizable monomers can be the same or different; m can be a number from 2 to 40; l can be a number from 0 to 20; T can be an organic linking group obtained by removing a hydrogen atom from a chain transfer agent, and the T residues can be the same or can be different; Z can be a residue obtained by removing a hydrogen atom from an isocyanate-reactive group or blocking group, and the Z residues can be the same or can be different; A can be a di- tri- or tetravalent residue obtained by removing 2, 3, or 4 —NCO groups from a corresponding isocyanate; a can be a number from 1 to 4, and b can be a number from 0 to 3, with the proviso that a+b has a value from 2 to 4.

The fluorinated polyurethanes of Formulas 4 and 5 can be prepared by reacting one or more fluorochemical oligomers represented by general Formula 6

M^{f}ₘM^{h}ₗ-TH, Formula 6

where M^{f}ₘM^{h}ₗ can be a fluorochemical spacer oligomer, that includes m units derived from a fluorochemical spacer monomer, M^{f}, and l units derived from one or more other polymerizable monomers, M^{h}, that can be fluorinated or fluorine-free, where the fluorochemical spacer monomers and polymerizable monomers can be the same or different; m can be a number from 2 to 40; l can be a number from 0 to 20; T can be an organic linking group obtained by removing a hydrogen atom from a chain transfer agent, and the T residues can be the same or can be different, with at least one isocyanate represented by general Formula 7

A(NCO)ₓ, Formula 7

where A can be defined as above and x can be a number from 2 to 4, and in the case of compounds of Formula 3, optionally at least one bifunctional active hydrogen compound represented by general Formula 8

HX—B—XH, Formula 8

where X and B are defined as above, and optionally at least one compound represented by general formula:

Z—H,

where Z can be a residue obtained by removing a hydrogen atom from an isocyanate-reactive group or blocking group, and the Z residues can be the same or can be different.

The fluorinated polyurethanes can be prepared in a two step reaction. For example, a functionalized fluorochemical spacer oligomer can be prepared, which can be further reacted to form a polyurethane. A fluorochemical oligomer can be prepared by free-radical oligomerization of fluorochemical spacer monomers alone or in combination with other polymerizable monomers, in the presence of hydroxy-, amino-, or mercapto-functionalized chain transfer agents. The fluorochemical spacer oligomer preferably comprises from 2 to about 40 polymerized units derived from fluorochemical spacer monomers and from 0 to about 20 polymerized units derived from other monomers.

Illustrative fluorochemical spacer monomers can include those discussed and described in U.S. Pat. No. 7,199,197 and U.S. Patent Application Publication No. 2005/0143541, and can include the reaction product of a) fluorochemical alcohol, b) one unbranched symmetric diisocyanate, and c) hydroxyl terminated alkyl(meth)acrylates.

Other suitable fluorochemical spacer monomers can be represented by the following general Formula 9:

CₙF₂ₙ₊₁—X′—OC(O)NH-A″—HNC(O)O—(CₚH₂ₚ)(O)COC(R′)═CH₂ Formula 9

where n can be 1 to 20, preferably 1 to 6, most preferably 4 to 6; X′ can be

[chemical structure]

where R can be H or an alkyl group of 1 to 4 carbon atoms; m can be 2 to 8; R_{f} can be CₙF₂₊₁; y can be 0 to 6; q can be 1 to 20; A″ can be an unbranched symmetric alkylene group, arylene group, or aralkylene group; p can be 2 to 30, and R′ can be H, CH₃, or F.

Suitable fluorochemical alcohols can be represented by the following general Formula 10:

CₙF₂ₙ₊₁—X′—OH Formula 10

where n can be 1 to 20; X′ can be

[chemical structure]

where R can be hydrogen or an alkyl group of 1 to 4 carbon atoms; m can be 2 to 8; R_{f} can be CₙF₂₊₁; n can be 1 to 4; y can be 0 to 6; and q can be 1 to 8.

Representative examples of suitable alcohols include, but are not limited to, CF₃CH₂OH, (CF₃)₂CHOH, (CF₃)₂CFCH₂OH, C₂F₅SO₂NH(CH₂)₂OH, C₂F₅SO₂NCH₃(CH₂)₂OH, C₂F₅SO2NCH3(CH2)4OH, C₂F₅SO₂NC₂H₅(CH₂)₆OH, C₂F₅(CH₂)₄OH, C₂F₅CONH(CH₂)₄OH, C₃F₇SO₂NCH₃(CH₂)₃OH, C₃F₇SO₂NH(CH₂)₂OH, C₃F₇CH₂OH, C₃F₇CONH(CH₂)₈OH, C₄F₉(CH₂)₂OH, C₄F₉SO₂NCH₃(CH₂)₂OH, C₄F₉CONH(CH₂)₂OH, C₄F₉SO₂NCH₃(CH₂)₄OH, C₄F₉SO₂NH(CH₂)₇OH, C₄F₉SO₂NC₃H₇(CH₂)₂OH, C₄F₉SO₂NC₄H₉(CH₂)₂OH, C₅F₁₁SO₂NCH₃(CH₂)₂OH, C₅F₁₁CONH(CH₂)₂OH, C₅F₁₁(CH₂)₄OH, C₆F₁₃CH₂CH₂OH, C₄F₉C₂H₄OH, and C₄F₉C₂H₄SC₂H₄OH.

Symmetric diisocyanates can include diisocyanates that meet the three elements of symmetry as defined by Hawley's Condensed Chemical Dictionary 1067 (1997). First, they have a center of symmetry, around which the constituent atoms are located in an ordered arrangement. There is only one such center in the molecule, which may or may not be an atom. Second, they have a plane of symmetry, which divides the molecule into mirror-image segments. Third, they have axes of symmetry, which can be represented by lines passing through the center of symmetry. If the molecule is rotated, it will have the same position in space more than once in a complete 360° turn.

As used herein, the term “unbranched” means that the symmetric diisocyanate does not contain any subordinate chains of one or more carbon atoms. Representative examples of unbranched symmetric diisocyanates include 4,4′-diphenylmethane diisocyanate (MDI), 1,6-hexamethylene diisocyanate (HDI), 1,4-phenylene diisocyanate (PDT), 1,4-butane diisocyanate (BDI), 1,8-octane diisocyanate (ODI), 1,12-dodecane diisocyanate, and 1,4-xylylene diisocyanate (XDI). Hydroxy-terminated alkyl (meth)acrylate and 2-fluoroacrylate monomers can have from 2 to about 30 carbon atoms (preferably, from 2 to about 12 carbon atoms) in their alkylene portion.

The fluorochemical spacer monomers can be prepared, for example, by first combining the fluorochemical alcohol and the unbranched symmetric diisocyanate in a solvent, and then adding the hydroxy-terminated alkyl (meth)acrylate. Useful solvents include esters (for example, ethyl acetate), ketones (for example, methyl ethyl ketone), ethers (for example, methyl-tert-butyl ether), and aromatic solvents (for example, toluene).

The reaction can be carried out in the presence of a catalyst. Useful catalysts can include, but are not limited to, bases (for example, tertiary amines, alkoxides, and carboxylates), metal salts and chelates, organometallic compounds, acids and urethanes. The catalyst can include organotin compounds (for example, dibutyltin dilaurate (DBTDL) or tertiary amines (for example, diazobicyclo[2.2.2]octane (DABCO)), any combination thereof, or any mixture thereof.

Other polymerizable moieties, M^{h}, for use in the functional spacer oligomer can include fluorochemical monomers which can be represented by the following general Formula 11:

[chemical structure]

where R_{f} can be CₙF₂ₙ₊₁, n can be 3 to 18, preferably 6 to 12; r can be 0 or 1; s can be 1 to 8, preferably 1 or 2; D can be a group comprising a radically polymerizable unsaturated residue; and R can be methyl or ethyl.

Fluorochemical monomers as described above and methods for the preparation thereof can be as discussed and described in U.S. Pat. No. 2,803,615. Examples of such compounds include general classes of fluorochemical acrylates, methacrylates, vinyl ethers, and allyl compounds containing fluorinated sulfonamido groups, acrylates or methacrylates derived from fluorochemical telomer alcohols, acrylates or methacrylates derived from fluorochemical carboxylic acids, and perfluoroalkyl acrylates or methacrylates as disclosed in EP-A-526 976.

Hydrocarbon monomers suitable for use as M^{h} in the preparation of the fluorochemical spacer oligomers can include general classes of ethylenic compounds capable of free-radical polymerization. Illustrative ethylenic compounds capable of free-radical polymerization can include, but are not limited to, allyl esters such as allyl acetate and allyl heptanoate; alkyl vinyl ethers or alkyl allyl ethers such as cetyl vinyl ether, dodecylvinyl ether, 2-chloroethylvinyl ether, ethylvinyl ether; unsaturated acids such as acrylic acid, methacrylic acid, alpha-chloro acrylic acid, crotonic acid, maleic acid, fumaric acid, itaconic acid and their anhydrides and their esters such as vinyl, allyl, methyl, butyl, isobutyl, hexyl, heptyl, 2-ethyl-hexyl, cyclohexyl, lauryl, stearyl, isobornyl or alkoxy ethyl acrylates and methacrylates; alpha-beta unsaturated nitriles such as acrylonitrile, methacrylonitrile, 2-chloroacrylonitrile, 2-cyanoethyl acrylate, alkyl cyanoacrylates; alpha, beta-unsaturated carboxylic acid derivatives such as allyl alcohol, allyl glycolate, acrylamide, methacrylamide, n-diisopropyl acrylamide, diacetoneacrylamide, N,N-diethylaminoethylmethacrylate, N-t-butylamino ethyl methacrylate; styrene and its derivatives such as vinyltoluene, alpha-methylstyrene, alpha-cyanomethyl styrene; lower olefinic hydrocarbons which can contain halogen such as ethylene, propylene, isobutene, 3-chloro-1-isobutene, butadiene, isoprene, chloro and dichlorobutadiene and 2,5-dimethyl-1,5-hexadiene, and allyl or vinyl halides such as vinyl and vinylidene chloride, vinyl caprolactam, and 1-vinyl-2-pyrrolidinone. Comonomers which can be copolymerized with the above-described fluoroaliphatic radical-containing monomers can include, but are not limited to, octadecylmethacrylate, 1,4-butanediol diacrylate, polyurethane diacrylates, polyethylene glycol diacrylates, polypropylene glycol diacrylates, laurylmethacrylate, butylacrylate, N-methylol acrylamide, isobutylmethacrylate, ethylhexyl acrylate, ethylhexyl methacylate, vinylchloride, vinylidene chloride, any combination thereof, or any mixture thereof.

The hydroxy-, amino and/or mercapto functionalized chain transfer agents T-H useful in the preparation of the fluorochemical spacer oligomer can include 2-mercaptoethanol, 3-mercapto-2-butanol, 3-mercapto-2-propanol, 3-mercapto-1-propanol, 3-mercapto-1,2-propanediol, 2,3-dimercaptopropanol, 2-mercapto-ethylamine and 2-mercaptoethylsulfide. A single compound or a mixture of different chain transfer agents can be used. The chain transfer agents used in the preparation of the fluorochemical oligomer can include only two functional groups so that after reaction with the oligomer only one isocyanate reactive group remains on the fluorochemical oligomer. In another embodiment, the M^{h} can be an isocyanate-reactive monomer, such as 2-hydroxyethylacrylate, in which case the chain transfer agent can optionally be functional.

A free-radical initiator can be present during preparation of the functionalized fluorochemical oligomer. Such flee-radical initiators can include azo compounds, hydroperoxides, dialkyl peroxides, peroxyesters, diacylperoxides, or any mixture thereof. Illustrative azo compounds can include, but are not limited to, azobisisobutyronitrile (AIBN) and azo-2-cyanovaleric acid. Illustrative hydroperoxides can include, but are not limited to, cumene, t-butyl, and t-amyl hydroperoxide. Illustrative dialkyl peroxides can include, but are not limited to, di-t-butyl and dicumylperoxide. Illustrative peroxyesters can include, but are not limited to, t-butylperbenzoate and di-t-butylperoxy phthalate. Illustrative diacylperoxides can include, but are not limited to, benzoyl peroxide and lauroyl peroxide.

The fluorochemical spacer oligomer can then be reacted with an isocyanate, and optionally a chain extender and optionally a blocking agent or other isocyanate-reactive agent. Suitable isocyanates A(NCO)_{X}, where x can be 2, 3, or 4, for use in preparing the fluorochemical polyurethanes of Formula 4 can include aromatic diisocyanates such as 4,4′-methylene-diphenylene diisocyanate (MDI) and 2,4-toluene diisocyanate (2,4-TDI); alicyclic diisocyanates such as 3-isocyanatomethyl-3,5,5-trimethyl-cyclohexyl isocyanate (IPDI), 1,4-cyclohexane diisocyanate and 4,4′-cyclohexylmethane diisocyanate; aliphatic diisocyanates such as methylene diisocyanate, 1,6-hexamethylene diisocyanate, 2,2,4-trimethyl-1,6-hexamethylene diisocyanate, and 1,2-ethylene diisocyanate; aliphatic triisocyanates such as 1,3,6-hexamethylenetriisocyanate; aromatic triisocyanates, such as 4,4′,4″-triphenylmethane triisocyanate; polyisocyanates such as polymethylene-polyphenyl-isocyanate (PAPI); isocyanurates, such as the trimer of hexamethylenediisocyanate and the trimer of IPDI, or any mixture thereof.

In the preparation of the fluorinated polyurethanes not only difunctional isocyanates, e.g., isocyanates A(NCO)₂, can be used, but also higher functional, e.g., trifunctional isocyanate can be employed. This means that the fluorinated polyurethanes can include not just linear compounds obtained from diisocyanates, but can include at least some sites of branching due to the inclusion of tri- or tetraisocyanates. In one example, at least 50% to about 90% of the isocyanates used can be triisocyanates.

Conventional blocking groups and/or isocyanate-reactive agents include alcohols such as methanol, ethanol, n-propyl alcohol, isopropyl alcohol, n-butyl alcohol, isobutyl alcohol, t-butyl alcohol, n-amyl alcohol, t-amyl alcohol, 2-ethylhexanol, glycidol, (iso)stearylalcohol; aryl alcohols (e.g., phenols, cresols, nitrophenols, o- and p-chlorophenol, napthols, 4-hydroxybiphenyl); fluorochemical alcohols such as:

[chemical structure]

and HFPO oligomer alcohol; C₂ to C₈ alkanone oximes (e.g., acetone oxime, butanone oxime); benzophenone oxime; aryl-thiols (e.g., thiophenol); organic carbanion active hydrogen compounds (e.g., diethyl malonate, acetylacetone, ethyl acetoacetate, ethylcyanoacetate); epsilon-caprolactam; primary or secondary amines (e.g., butyl amine); hydroxylamine; primary amino mercaptans and secondary amino mercaptans. A single compound or a mixture of different masking or blocking agents can be used. In some examples, blocking agents can include C₂ to C₈ alkanone oximes, e.g., 2-butanone oxime, monofunctional alcohols, such as 2-ethylhexanol and (iso)stearylalcohol.

Difunctional chain extenders HX—B—XH suitable in the formation of the fluorinated polyurethanes can include difunctional alcohols, thiols and amines. A single compound or a mixture of different chain extenders can be used. Examples include diols such as 1,4-butanediol, 1,6-hexanediol, 1-10-decanediol, 4,4′-isopropylidene diphenol (Bisphenol A); polyester diols, such as polycaprolactone diol, fatty acid dimer diols and poly(oxy)alkylenediols with an oxyalkylene group having 2 to 4 carbon atoms, such as OCH₂CH₂—, —O(CH₂)₄—, —OCH₂CH₂CH₂—, —OCH(CH₃)CH₂— and —OCH(CH₃)CH(CH₃)— (preferably the oxyalkylene units in said poly(oxyalkylene) being the same, as in polypropyleneglycol or present as a mixture). The group B can include siloxane groups, such as dimethylsiloxane groups. Furthermore, the group B can be partially fluorinated in order to enhance the oil- and water-repellent characteristics of the compound.

Further examples of multifunctional chain extenders that can be used include polyols that can include at least one fluorine-containing group, such as perfluoroalkyl, perfluoroheteroalkyl, and perfluoroalkylene moieties. The perfluorocarbon chains that include these perfluoro moieties can include about 6 carbon atoms or less. Perfluoroalkyl moieties can be used, such as perfluoroalkyl moieties that have about 6 carbon atoms or less, for example, such as about 3 to about 5 carbon atoms. Perfluoroheteroalkyl moieties can have about 3 to about 50 carbon atoms. Perfluoroheteroalkylene groups can have about 3 to about 50 carbon atoms. Perfluoroheteroalkyl and alkylene moieties are preferably perfluoropolyethers with no perfluorocarbon chain of more than six carbon atoms.

Suitable fluorinated polyols that include at least one fluorine-containing group can include, but are not limited to, R_{f}SO₂N(CH₂CH₂OH)₂ such as N-bis(2-hydroxyethyl)perfluorobutylsulfonamide; R_{f}OC₆H₄SO₂N(CH₂CH₂OH)₂; R_{f}SO₂N(R′)CH₂CH(OH)CH₂OH such as C₆F₁₃SO₂N(C₃H₇)CH₂CH(OH)CH₂OH; R_{f}CH₂CON(CH₂CH₂OH)₂; R_{f}CON(CH₂CH₂OH)₂; CF₃CF₂(OCF₂CF₂)₃OCF₂CON(CH₃)CH₂CH(OH)CH₂OH; R_{f}OCH₂CH(OH)CH₂OH such as C₄F₉OCH₂CH(OH)CH₂OH; R_{f}CH₂CH₂SC₃H₆OCH₂CH(OH)CH₂OH; R_{f}CH₂CH₂SC₃H₆CH(CH₂OH)₂; R_{f}CH₂CH₂SCH₂CH(OH)CH₂OH; R_{f}CH₂CH₂SCH(CH₂OH)CH₂CH₂OH; R_{f}CH₂CH₂CH₂SCH₂CH(OH)CH₂OH such as C₅F₁₁(CH₂)₃SCH₂CH(OH)CH₂OH; R_{f}CH₂CH₂CH₂OCH₂CH(OH)CH₂OH such as C₅F₁₁(CH₂)₃OCH₂CH(OH)CH₂OH; R_{f}CH₂CH₂CH₂OC₂H₄OCH₂CH(OH)CH₂OH; R_{f}CH₂CH₂(CH₃)OCH₂CH(OH)CH₂OH; R_{f}(CH₂)₄SC₃H₆CH(CH₂OH)CH₂OH; R_{f}(CH₂)₄SCH₂CH(CH₂OH)₂; R_{f}(CH₂)₄SC₃H₆OCH₂CH(OH)CH₂OH; R_{f}CH₂CH(C₄H₉)SCH₂CH(OH)CH₂OH; R_{f}CH₂OCH₂CH(OH)CH₂OH; R_{f}CH₂CH(OH)CH₂SCH₂CH₂OH; R_{f}CH₂CH(OH)CH₂SCH₂CH₂OH; R_{f}CH₂CH(OH)CH₂OCH₂CH₂OH; R_{f}CH₂CH(OH)CH₂OH; R_{f}R″SCH(R′″OH)CH(R′″OH)SR″R_{f}; (R_{f}CH₂CH₂SCH₂CH₂SCH₂)₂C(CH₂OH)₂; ((CF₃)₂CFO(CF₂)₂(CH₂)₂SCH₂)₂C(CH₂OH)₂; (R_{f}R′SCH₂)₂CH(CH₂OH)₂; 1,4-bis(1-hydroxy-1,1-dihydroperfluoroethoxyethoxy)perfluoro-n-butane (HOCH₂CF₂OC₂F₄O(CF₂)₄OC₂F₄OCF₂CH₂OH); 1,4-bis(1-hydroxy-1,1-dihydroperfluoropropoxy)perfluoro-n-butane (HOCH₂CF₂CF₂O(CF₂)₄OCF₂CF₂CH₂OH); fluorinated oxetane polyols made by the ring-opening polymerization of fluorinated oxetane such as Poly-3-Fox™ available from Omnova Solutions, Inc., Akron Ohio; polyetheralcohols prepared by ring opening addition polymerization of a fluorinated organic group substituted epoxide with a compound containing at least two hydroxyl groups as described in U.S. Pat. No. 4,508,916; and perfluoropolyether diols such as FOMBLIN® Z DOL (HOCH₂CF₂O(CF₂O)₈₋₁₂(CF₂CF₂O)₈₋₁₂CF₂CH₂OH available from Ausimont, where R_{f} can be a perfluoroalkyl group having 1 to 6 carbon atoms, or a perfluoroheteroalkyl group having 3 to about 50 carbon atoms with all perfluorocarbon chains present having 6 or fewer carbon atoms, or mixtures thereof; R′ can be alkyl of 1 to 4 carbon atoms; R″ can be branched or straight chain alkylene of 1 to 12 carbon atoms, alkylenethio-alkylene of 2 to 12 carbon atoms, alkylene-oxyalkylene of 2 to 12 carbon atoms, or alkylene iminoalkylene of 2 to 12 carbon atoms, where the nitrogen atom can include a third substituent, such as hydrogen or alkyl of 1 to about 6 carbon atoms; and R′″ can be a straight or branched chain alkylene of 1 to about 12 carbon atoms or an alkylene-polyoxyalkylene of formula CᵣH₂ᵣ(OCSH₂S)ₙ, where r can be 1-12, s can be 2-6, and t can be 1-40.

The reaction can be under conventional urethane forming conditions. For example, the reaction can be carried out under dry conditions preferably in a polar solvent such as ethyl acetate, acetone, methyl ethyl ketone and methyl isobutyl ketone. The reaction can be run in the presence of a catalyst. The catalysts can include, but is not limited to, tin salts such as dibutyltin dilaurate and stannous octoate. Suitable reaction temperatures can be readily determined by those skilled in the art based on the particular reagents, solvent, and catalysts being used.

At least one commercially available fluorinated polyurethane can include the 3M® Stain Resistant Additive SRC-220 available from 3M, St. Paul, Minn. SRC-220 is a polyurethane modified with perfluoralkylsulfonamide and emulsified in water and 2-methoxymethylethoxypropanol.

The fluoroacrylate monomers used to synthesized the flouroacrylate polymers can also be represented by the following general Formula 12:

CₙF₂ₙ₊₁—X—OC(O)NH-A-HNC(O)O—(CₚH₂ₚ)(O)COC(R′)═CH₂ Formula 12

where n can be a number from 1 to 5, X can be represented by the following general Formula 13:

[chemical structure]

R can be a hydrogen or an alkyl group of 1 to 4 carbon atoms, m can be a number from 2 to 8, R_{f} can be represented by the formula CₙF₂ₙ₊₁, y can be a number from 0 to 6, q can be a number from 1 to 8, A can be an unbranched symmetric alkylene group, arylene group, or aralkylene group, p can be a number from 2 to 30, and R′ can be hydrogen, CH₃, or F. Preferably, n can be a number from 1 to 4; more preferably, n can be 4. A can be one of —C6H12-,

[chemical structure]

Fluoroacrylates can be polymerized to yield a fluorinated acrylic polymer. Fluorinated acrylic polymers that include repeating units of fluoroacrylates can exhibit water- and oil-repellency properties.

Fluoroacrylates can also be copolymerized with one or more nonfunctional comonomers and/or functional comonomers. Nonfunctional comonomers such as, for example, alkyl acrylates can improve durability and film-forming properties. Representative examples of nonfunctional comonomers can include, but are not limited to, methyl (meth)acrylate, butyl acrylate, isobutyl (meth)acrylate, hexyl acrylate, dodecyl acrylate, and octadecyl acrylate. Nonfunctional comonomers can typically be copolymerized with the fluoroacrylates in a molar ratio of up to about 1:1.

Functional comonomers can provide properties such as, for example, adhesion, hydrophilicity, reactivity, or low glass transition temperatures. Groups that are useful in functional comonomers can include, but are not limited to, hydroxy, carboxy, quaternary ammonium, acetate, pyrrolidine, polyethylene glycol, sulfonic acid, trialkoxysilane, and silicone. These groups can generally be introduced into the polymer at less than 20 weight percent (preferably, less than 5 weight percent). Other functional comonomers can include, but are not limited to, acrylic acid, methacrylic acid, N-vinyl 2-pyrrolidinone, and hydroxypropyl acrylate.

Fluoroacrylates can also be polymerized with methacrylate functional polydimethyl siloxanes such as, for example, methacryloxy propyl polydimethyl silicone, to prepare fluorinated acrylic/siloxane graft copolymers.

The hydrophobizing agent can include 3M® Stain Resistant Additive and Sealer SRA-250 (SRA-250) available from 3M St. Paul, Minn. The fluorinated acrylate polymer of SRA-250 can be mixed with water and sodium tetrapropylbenzene sulfonate.

Olefin metathesis product can include one or more compounds that contain at least one carbon-carbon double bond that can be suitable for a metathesis reaction. Metathesis reactions include, for example, self-metathesis, cross-metathesis, ring-opening metathesis, ring-opening metathesis polymerizations (ROMP), ring-closing metathesis (RCM), and acyclic diene metathesis (ADMET). Examples of metathesis compositions, processes, and products are reported in R. L. Pederson, Commercial Applications of Ruthenium Metathesis Processes; in “Handbook of Metathesis”; Vol. 2; R. H. Grubbs Ed.; Wiley-VCH Weinheim, Germany; 2003; pp. 491 to 510 (ISBN No. 3-527-30616-1).

The olefin metathesis product can made from a metathesis composition that can include polyol esters of unsaturated fatty acids. The polyol esters can include one or more of monoacylglycerides, diacylglycerides, and triacylglycerides. The polyol esters can be derived from vegetable or animal origin. Suitable vegetable oils that include polyol esters of unsaturated fatty acids can include soybean oil (including modified soybeans such as low linolenic varieties), palm oil, palm kernel oil, coconut oil, cocoa butter, corn oil, peanut oil, cottonseed oil, canola oil (including high oleic varieties), sunflower oil (including high oleic varieties), castor oil, safflower oil, tall oil, tung oil, linseed oil, jojoba oil, olive oil, used fry oils from food processing operations, and the like. Suitable animal oils can include tallow, lard, fish oil, chicken fat, or any mixture thereof. In some embodiments, the metathesis composition can be refined, bleached, and deodorized (e.g., RBD) soybean oil. The metathesis compositions can include esters of the fatty acids provided by the oils and fats and molecules with a single hydroxy site such as fatty acid methyl esters.

As used herein, “polyol esters” refers to esters produced from polyols. Polyols may include more than two hydroxyl groups. These polyols may comprise from two to about 10 carbon atoms, and can comprise from two to six hydroxyl groups, but other numbers of carbon atoms and/or hydroxyl groups are possible as well. The polyols can contain two to four hydroxyl moieties. Non-limiting examples of polyols include glycerin, 1,2-propanediol, 1,3-propanediol, 1,2-butanediol, 1,3-butanediol, 2,3-butanediol, 2-ethyl-1,3-propanediol, 2-ethyl-2-butyl-1,3-propanediol, neopentyl glycol, 2,2,4-trimethyl-1,3-pentanediol, trimethylolpropane (TMP), sorbitol and pentaerythritol. The polyol esters can be esters of glycerin, e.g., triacylglycerides, or esters of a mixture of glycerin and one or more other polyols.

The polyol ester component can include a partial fatty acid ester of one or more polyols and/or a polyol which can be fully esterified with fatty acids (complete polyol fatty acid ester). Examples of polyol fatty acid esters can include triacylglycerides, propylene glycol diesters and tetra esters of pentaerythritol. Examples of suitable polyol partial esters can include fatty acid monoglycerides, fatty acid diglycerides and sorbitan partial esters (e.g., diesters and triesters of sorbitan). In an embodiment, the polyol can include from 2 to 6 carbon atoms and 2 to 6 hydroxyl groups. Examples of suitable polyols can include glycerol, trimethylolpropane, ethylene glycol, propylene glycol, pentaerythritol, sorbitan and sorbitol.

In an embodiment, the polyol esters can be metathesized and hydrogenated to form an olefin metathesis product or hydrophobizing agent. For example, refined, bleached and deodorized (RBD) soybean oil can be self-metathesized in the presence of a metathesis catalyst to form a metathesis product. The resulting metathesis product can then be hydrogenated without first removing the metathesis catalyst to form a hydrogenated metathesis product in the form of a wax. Subsequent removal of the hydrogenation catalyst can result in removal of at least a portion of the transition metal from the metathesis catalyst. Wax compositions comprising hydrogenated metathesis products can include those discussed and described in WO Publication No. WO 06/076364.

The metathesis reaction can be conducted in the presence of a catalytically effective amount of a metathesis catalyst. The term “metathesis catalyst” includes any catalyst or catalyst system which catalyzes the metathesis reaction. Any known metathesis catalyst can be used, alone or in combination with one or more additional catalysts. Suitable metathesis catalysts can include metal carbene catalysts based upon transition metals, for example, ruthenium, molybdenum, osmium, chromium, rhenium, and tungsten. Suitable ruthenium-based metathesis catalysts, illustrated below, can include those represented by structures 1 (commonly known as Grubbs's catalyst), 2 and 3, where Ph is phenyl, Mes is mesityl, and Cy is cyclohexyl. Structures 4, 5, 6, 7, 8, and 9, represent additional ruthenium-based metathesis catalysts, where Ph is phenyl, Mes is mesityl, py is pyridine, Cp is cyclopentyl, and Cy is cyclohexyl. Techniques for using catalysts 1, 2, 3, 4, 5, 6, 7, 8, and 9, as well as additional related metathesis catalysts, are known in the art. Catalysts 11, 12, 13, 14, and 15 are additional ruthenium-based catalysts that can be used.

[chemical structure]

[chemical structure]

[chemical structure]

Additional metathesis catalysts can include, but are not limited to, metal carbene complexes of molybdenum, osmium, chromium, rhenium, and tungsten. The term “complex” refers to a metal atom, such as a transition metal atom, with at least one ligand or complexing agent coordinated or bound thereto. Such a ligand typically is a Lewis base in metal carbene complexes useful for alkyne or alkene-metathesis. Suitable ligands can include phosphines, halides and stabilized carbenes. Some metathesis catalysts can employ plural metals or metal co-catalysts (e.g., a catalyst comprising a tungsten halide, a tetraalkyl tin compound, and an organoaluminum compound).

An immobilized catalyst can be used for the metathesis process. An immobilized catalyst can be a system comprising a catalyst and a support, the catalyst associated with the support. Exemplary associations between the catalyst and the support may occur by way of chemical bonds or weak interactions (e.g., hydrogen bonds, donor acceptor interactions) between the catalyst, or any portions thereof, and the support or any portions thereof. The support can include any material suitable to support the catalyst. Immobilized catalysts can be solid phase catalysts that act on liquid or gas phase reactants and products. Exemplary supports can include polymers, silica or alumina. Such an immobilized catalyst can be used in a flow process. An immobilized catalyst can simplify purification of products and recovery of the catalyst so that recycling the catalyst may be more convenient.

The metathesis process can be conducted under any conditions adequate to produce the desired metathesis products. For example, stoichiometry, atmosphere, solvent, temperature and pressure can be selected to produce a desired product and to minimize undesirable byproducts. The metathesis process can be conducted under an inert atmosphere. Similarly, if the olefin reagent can be supplied as a gas, an inert gaseous diluent can be used. The inert atmosphere or inert gaseous diluent can be an inert gas, meaning that the gas does not interact with the metathesis catalyst to substantially impede catalysis. Suitable inert gases can be helium, neon, argon, nitrogen, and combinations thereof.

If a solvent is used, the solvent chosen can be selected to be substantially inert with respect to the metathesis catalyst. For example, substantially inert solvents can include, but are not limited to, aromatic hydrocarbons, such as benzene, toluene, and xylene; halogenated aromatic hydrocarbons, such as chlorobenzene and dichlorobenzene; aliphatic solvents, such as pentane, hexane, heptane, and cyclohexane; and chlorinated alkanes, such as dichloromethane, chloroform, and dichloroethane.

In an embodiment, a ligand can be added to the metathesis reaction mixture. The ligand can be selected to be a molecule that stabilizes the catalyst, and can thus provide an increased turnover number for the catalyst. The ligand can alter reaction selectivity and product distribution. Examples of ligands that can be used can include, but are not limited to, Lewis base ligands, such as, trialkylphosphines, for example tricyclohexylphosphine and tributyl phosphine; triarylphosphines, such as triphenylphosphine; diarylalkylphosphines, such as, diphenylcyclohexylphosphine; pyridines, such as 2,6-dimethylpyridine, 2,4,6-trimethylpyridine; as well as other Lewis basic ligands, such as phosphine oxides and phosphinites. Additives can also be present during metathesis that increase catalyst lifetime.

Any useful amount of the selected metathesis catalyst can be used in the process. For example, the molar ratio of the unsaturated polyol ester to catalyst can be about 5:1 to about 10,000,000:1 or about 50:1 to 500,000:1.

The metathesis reaction temperature can be a rate-controlling variable where the temperature can be selected to provide a desired product at an acceptable rate. The metathesis temperature can be from a low of about −40° C., about −20° C., or about −10° C. to a high of about 100° C., about 130° C., or about 160° C. In another example, the metathesis temperature can be about −35° C. to about −20° C., about −10° C. to about 0° C., about 5° C. to about −30° C., about 50° C. to about 80° C., about 90° C. to about 120° C., about 110° C. to about 130° C., or about 130° C. to about 150° C.

The metathesis reaction can be run under any pressure. The total pressure for the metathesis reaction can be from a low of about 10 kPa, about 20 kPa, about 50 kPa, about 100 kPa to a high of about 800 kPa, about 1,500 kPa, about 3,000 kPa. In another example, the total pressure for the metathesis reaction can be about 10 kPa to about 120 kPa, about 100 kPa to about 200 kPa, about 300 kPa to about 600 kPa, about 700 kPa to about 1,200 kPa, about 1,800 kPa to about 2,400 kPa, about 2,000 kPa to about 2,600 kPa, about 2,100 kPa to about 3,000 kPa.

In an embodiment, the metathesis reaction can be catalyzed by a system containing both a transition and a non-transition metal component. The catalyst systems can be derived from Group VI A transition metals, for example, tungsten and molybdenum.

The metathesis product can be hydrogenated using a catalyst that contains one or more metals, such as nickel, copper, palladium, platinum, molybdenum, iron, ruthenium, osmium, rhodium, iridium, or alloys thereof. Combinations of catalysts can also be used. The catalysts can be heterogeneous or homogeneous.

In an embodiment, the catalysts can be supported nickel or sponge nickel type catalysts. The nickel catalyst can be chemically reduced with hydrogen to an active state (e.g., reduced nickel) provided on a support. In another embodiment, the support can be porous silica (e.g., kieselguhr, infusorial, diatomaceous, or siliceous earth) or alumina. The catalyst can be characterized by a high nickel surface area per gram of nickel.

In an embodiment, the particles of supported nickel catalyst can be dispersed in a protective medium such as hardened triacylglyceride, edible oil, or tallow. In an exemplary embodiment, the supported nickel catalyst can be dispersed in the protective medium at a level of about 22 wt % nickel.

In an embodiment, the supported nickel catalysts can be of the type reported in U.S. Pat. No. 3,351,566. These catalysts can be solid nickel-silica and can have a stabilized high nickel surface area of about 45 sq. meters per gram to about 60 sq. meters per gram and can have a total surface area of about 225 sq. meters per gram to about 300 sq. meters per gram. The catalysts can be prepared by precipitating the nickel and silicate ions from solution such as nickel hydrosilicate onto porous silica particles in such proportions that the activated catalyst can include about 25 wt % to about 50 wt % nickel and a total silica content of about 30 wt % to about 90 wt %. The particles can be activated by calcining in air at about 315° to about 500° C., then reducing with hydrogen.

Suitable catalysts having a high nickel content can include those discussed and described in EP 0 168 091, where the catalyst can be made by precipitation of a nickel compound. A soluble aluminum compound can be added to the slurry of the precipitated nickel compound while the precipitate is maturing. After reduction of the resultant catalyst precursor, the reduced catalyst can have a nickel surface area of about 90 m² to about 150 m² per gram of total nickel. The catalysts can have a nickel/aluminum atomic ratio of about 2 to about 10 and have a total nickel content of greater than 66 wt %.

Suitable high activity nickel/alumina/silica catalysts can include those discussed and described in EP 0 167 201. The reduced catalysts can have a high nickel surface area per gram of total nickel in the catalyst. Suitable nickel/silica hydrogenation catalysts can include those discussed and described in U.S. Pat. No. 6,846,772. The catalysts can be produced by heating a slurry of particulate silica (e.g., kieselguhr) in an aqueous nickel amine carbonate solution for a total period of at least 200 minutes at a pH of greater than 7.5, followed by filtration, washing, drying, and optionally calcination. Suitable high surface area nickel/alumina hydrogenation catalysts can include those discussed and described in U.S. Pat. No. 4,490,480. These catalysts can have a total nickel content of about 5 wt % to about 40 wt %. Commercial examples of supported nickel hydrogenation catalysts can include NYSOFACT®, NYSOSEL®, and NI 5248 D®, available from BASF. Additional supported nickel hydrogenation catalysts can include those commercially available under the trade designations PRICAT® 9910, PRICAT® 9920, PRICAT® 9908, PRICAT® 9936, and PRICAT® 9925, available from Johnson Matthey Catalysts.

Hydrogenation can be carried out in a batch or in a continuous process and can be partial hydrogenation or complete hydrogenation. In a representative batch process, a vacuum can be pulled on the headspace of a stirred reaction vessel and the reaction vessel can be charged with soybean oil (e.g., RBD soybean oil). The soybean oil can be heated to a desired temperature. The temperature can be about 50° C. to about 350° C., for example, about 100° C. to about 300° C. or about 150° C. to about 250° C. The temperature can vary with hydrogen gas pressure. A higher gas pressure can require a lower temperature. In a separate container, the hydrogenation catalyst can be weighed into a mixing vessel and can be slurried with a small amount of soybean oil. When the soybean oil reaches the desired temperature, the slurry of hydrogenation catalyst can be added to the reaction vessel. Hydrogen gas can then pumped into the reaction vessel to achieve a desired pressure of H₂ gas. The H₂ gas pressure can be from a low of about 10 psig, about 25 psig, or about 45 psig to about 2,000 psig, about 2,500 psig, or about 3000 psig. In another example, the H₂ gas pressure be about 10 psig to about 30 psig, about 50 psig to about 75 psig, about 100 psig to about 300 psig, about 800 psig to about 1,300 psig, about 1,100 psig to about 2,000 psig, about 2,100 psig to about 3,000 psig. As the gas pressure increases, more specialized high-pressure processing equipment may be required. Under these conditions the hydrogenation reaction begins and the temperature can be increased to the desired hydrogenation temperature, where it can be maintained by cooling the reaction mass, such as with cooling coils. The hydrogenation temperature can be from a low of about 0° C., about 10° C., or about 20° C. to a high of about 100° C., about 160° C., or about 230° C. In another example, the hydrogenation temperature can be from 2° C. to about 15° C., about 18° C. to about 25° C., about 25° C. to about 40° C., about 45° C. to about 80° C., about 90° C. to about 120° C., about 140° C. to about 160° C., or about 160° C. to about 220° C. When the desired degree of hydrogenation is reached, the reaction mass can be cooled to the desired filtration temperature.

The amount of hydrogenation catalysts can be selected in view of any one or more of a number of factors including, for example, the type of hydrogenation catalyst used, the amount of hydrogenation catalyst used, the degree of unsaturation in the metathesis product, the desired rate of hydrogenation, the desired degree of hydrogenation (e.g., as measure by iodine value (IV)), the purity of the reagent, and the H₂ gas pressure. The hydrogenation catalyst can be used in an amount from a low about 0.5 wt %, about 1 wt %, or about 2 wt % to a high of about 8 wt %, about 10 wt %, or about 12 wt %, based on the weight of the hydrogenation reaction mixture. In another example, the hydrogenation catalyst can be used in an amount of about 0.6 wt % to about 1.2 wt %, about 1.1 wt % to about 2.3 wt %, about 2.2 wt % to about 3.2 wt %, about 3.2 wt % to about 4.2 wt %, about 4 wt % to about 6.2 wt %, about 6 wt % to about 8.2 wt %, about 9 wt % to about 11.8 wt %, based on the hydrogenation reaction mixture.

After hydrogenation, the used hydrogenation catalyst can be removed from the hydrogenated metathesized product using known techniques such as filtration. In an embodiment, the hydrogenation catalyst can be removed using a plate and frame filter such as those commercially available from Sparkle Filters, Inc., Conroe Tex. In another embodiment, the filtration can be performed with the assistance of pressure or a vacuum. In order to improve filtering performance, a filter aid can be used. A filter aid may be added to the metathesized product directly or it may be applied to the filter. Representative examples of filtering aids can include diatomaceous earth, silica, alumina, and carbon. The filtering aid can be used in an amount of about 10 wt % or less, for example, about 5 wt % or less or about 1 wt % or less. Other filtering techniques and filtering aids may also be employed to remove the used hydrogenation catalyst. In other embodiments the hydrogenation catalyst can be removed using centrifugation followed by decantation of the product.

After filtering, the hydrogenated metathesis products can contain less than 100 ppm of the metathesis catalyst transition metal. In another embodiment, the hydrogenated metathesis products contain less than 10 ppm of the metathesis catalyst transition metal. In still another embodiment, the hydrogenated metathesis products can contain less than 1 ppm of the metathesis catalyst transition metal, for example, about 0.9 ppm or less, about 0.8 ppm or less, about 0.7 ppm or less, about 0.6 ppm or less, about 0.5 ppm or less, about 0.4 ppm or less, about 0.3 ppm or less, or about 0.1 ppm or less. In an embodiment, the metathesis catalyst can be a ruthenium-based catalyst and the hydrogenated metathesis product that contains less than 0.1 ppm ruthenium. One commercially available olefin metathesis product that can be used as the hydrophobizing agent can include NATUREWAX®, available from Elevance Renewable Sciences. Illustrative processes for making a hydrogenated metathesis product can include those discussed and described in U.S. Pat. No. 8,115,021 and U.S. Patent Application Publication No. 2009/0264672.

Several processes by which polyhydroxyalkanoates (“PHAs”) can be extracted from biomass are described in the art. These processes include PHA extraction though the use of enzymes, chemicals, mechanical means, and solvent extraction, including extraction through the use of acetone and ketones. Without wishing to be bound by theory, it is believed that the use of acetone under particular conditions maximizes both the yield and purity of the extracted PHAs; and minimizes the number of steps in the overall extraction process and therefore at least partially accomplishes the objective of economical, commercial extraction of PHAs.

PHA polymers produced by plant or microbial organisms either naturally or through genetic engineering, or PHAs that are synthetically produced. PHA is a polymer made from repeating units having the following general formula:

[chemical structure]

where R₁ can be Hydrogen, an alkyl, or an alkenyl; p can be a number from 0 to 3; and n can be an integer. PHA can consist entirely of a single monomeric repeating unit, in which case it is referred to as a homopolymer. For example, polyhydroxybutyrate (PHB) homopolymer has repeating monomeric units where R₁═C₁ alkyl, and p=1. Copolymers, in contrast, contain two or more different types of monomeric units. PHBV, for example, is a copolymer containing polyhydroxybutyrate and polyhydroxyvalerate (R₁═C₂ alkyl, and p=1) units. Another copolymer of interest contains 3-hydroxybutyrate and 4-hydroxybutyrate units. When three different types of repeating units are present the polymer can also be referred to as a terpolymer.

The polyhydroxyalkanoate can include at least two randomly repeating monomer units, where the first randomly repeating monomer unit has the structure:

[chemical structure]

and the second or higher randomly repeating monomer unit has the structure:

[chemical structure]

where R can be a C₂ to C₇ alkyl and about 75 mol % to about 99 mol % of the randomly repeating monomer units have the structure of the first randomly repeating monomer unit and about 1 mol % to about 25 mol % of the randomly repeating monomer units have the structure of the second randomly repeating monomer.

The PHAs can be modified to contain hydroxy-terminated end groups. Hydroxy terminated PHAs that can be used in the production of graft, random, and block polymers and copolymers with can include those discussed and described in U.S. Pat. No. 5,994,478.

Suitable PHAs can be recovered from any plant type. For example, the plants can be monocots or divots and suitable plant source materials can be derived from roots, stems, leaves, flowers, fruits, and/or seeds. In some examples, the biomass sources can include corn stover, switchgrass, sugarcane, or oilseed crops. For oilseed crops, such as canola, rapeseed, soybean, safflower, and sunflower, genetic engineering can produce plants in which PHA can be biosynthetically produced in the seeds of the crops. In order to recover PHA polymer from the seeds of such plants, it can be desirable to separate the polymer from the vegetable oil and oilseed meal also present. For example they can be crushed and/or dehulled and/or protein extracted prior to PHA extraction, although not necessarily in this order. The oilseed meal which can be separated from the PHA-enriched solvent can be further processed and utilized as animal feed, or, utilized as an additive in animal feed.

The solvents discussed and described herein can be used in the extraction and recovery of PHA polymers from oil-bearing seeds that include a mixture of vegetable oil, oilseed meal, and PHA. The vegetable oil from the seeds can be extracted, for example using hexane or another suitable solvent, and the oil-enriched solvent mixture can be separated from the PHA-meal mixture. The PHA in the PHA-meal mixture can then be selectively solubilized using one or more of the disclosed solvents, and PHA polymer can be recovered by conventional approaches such as cooling or solvent evaporation. Alternatively, the PHA can be precipitated from the PHA-enriched solvent mixture using the disclosed non-halogenated PHA-poor solvents.

The separation of the meal from the PHA solution via filtration can be problematic because the meal often has a consistency that makes it difficult for the PHA solution to permeate through the meal. As a result, the filter can become plugged. In some examples, the meal can be washed with water or hexane prior to the PHA dissolution.

The PHA and oil can be co-dissolved from a mixture of oil, oilseed meal, and PHA, separating the PHA-enriched solvent/oil mixture from the oilseed meal and any other residual biomass components, and precipitating PHA from the PHA-enriched solvent oil mixture.

Useful PHA-good solvents can include cyclic and acyclic (linear and branched) R′—OH alcohols, where R′ can be C₄-C₁₀, cyclic and acyclic; R″—COOR′″ esters, where R″ can be hydrogen or C₁-C₆ and R′″ can be C₁-C₇; cyclic and acyclic R″COOR′″ esters, where R″ can be hydrogen or C₁-C₆ and R′″ can be C₁-C₇ and where at least one oxygen can be substituted for at least one carbon in R″ or R′″; cyclic and acyclic R¹—CON—(R²)₂ amides, where R¹ can be hydrogen or C₁-C₆ and R² can be C₁-C₆; and cyclic and acyclic R³—CO—R⁴ ketones, where R³ can be C₁-C₆ and R⁴ can be C₁-C₆.

Other non-petroleum based hydrophobizing agents can include, but are not limited to: the microencapsulated materials SHP 50 and SHP 60+, available from Dow Corning Corp.; polyvinyl acetate, VAE copolymer, acrylic, polyurethane, XJ-551, dextrin and natural rubber latex emulsions, all available from IFS industries; Bio-Resin, available from Danimer Scientific, LLC; ChemBead, available from BYK USA Inc.; ethylene bis-stearamide; and olestra.

The hydrophobizing agent can be contained within a plurality of capsules or other enclosed shells or containers to inhibit or prevent direct contact with the liquid media. The capsules can break, burst, fracture, or otherwise permit the hydrophobizing agent contained therein to escape at a desired time or after a desired time. For example, pressure and/or heat applied to a plurality of particulates to which the hydrophobizing agent has been applied can cause the capsules to fracture, releasing the compound(s) contained within the capsules.

The capsules, if used to encapsulate one or more hydrophobizing agents, can be micro-capsules. Micro-capsules can have an average cross-sectional size of about 0.25 μm to about 1,000 μm. For example, the micro-capsules can have an average cross-sectional size from a low of about 1 μm, about 5 μm, or about 10 μm to a high of about 100 μm, about 200 μm, about 400 μm, or about 600 μm. The capsules, if used to encapsulate one or more hydrophobizing agents, can be macro-capsules. Macro-capsules can have an average cross-sectional size of about 1,000 μm to about 10,000 μm. For example, the macro-capsules can have an average cross-sectional size from a low of about 1,000 μm, about 1,500 μm, or about 2,000 μm to a high of about 5,000 μm, about 7,000 μm, or about 9,000 μm. Techniques for the encapsulation of various compounds are discussed and described in U.S. Pat. Nos. 4,536,524; 5,435,376; 5,532,293; 5,709,340; 5,911,923; 5,919,407; 5,919,557; 6,004,417; 6,084,010; 6,592,990; 6,703,127; 6,835,334; 7,286,279; 7,300,530; 7,309,500; 7,323,039; 7,344,705; 7,376,344; 7,550,200.

Preparation of the capsules can include, but is not limited to, interfacial polymerization, phase separation processes, or coacervation processes. Encapsulation methods can also include reaction in an aqueous medium conducted in the presence of negatively-charged, carboxyl-substituted, linear aliphatic hydrocarbon polyelectrolyte material dissolved in the aqueous medium, or reaction in the presence of gum arabic, or reaction in the presence of an anionic polyelectrolyte and an ammonium salt of an acid.

Numerous patents discuss and describe the various techniques that can be used to encapsulate various compounds using various encapsulation materials. For example, U.S. Pat. No. 7,323,039 discloses emulsion methods for preparing core/shell microspheres using an in-water drying method, after which the microspheres are recovered from the emulsion by centrifuging, filtering, or screening. U.S. Pat. No. 7,286,279 discloses microencapsulation processes and compositions prepared in a solution comprising a polymer precursor such as a monomer, chain extender, or oligomer; emulsifying the precursor into a fluorinated solvent; and forming microparticles by hardening the emulsion by polymerization/crosslinking the precursor, including interfacial and/or in-situ polymerization/crosslinking. U.S. Pat. No. 7,376,344 discloses heat sensitive encapsulation. U.S. Pat. No. 7,344,705 discloses preparation of low density microspheres using a heat expansion process, where the microspheres include biocompatible synthetic polymers or copolymers. U.S. Pat. Nos. 7,309,500 and 7,368,130 disclose methods for forming micro-particles, where droplets of chitosan, gelatin, hydrophilic polymers such as polyvinyl alcohol, proteins, peptides, or other materials can be charged in an immiscible solvent to prevent them from coalescing before hardening, optionally treating the gelated micro-particles with a crosslinking agent to modify their mechanical properties. U.S. Pat. No. 7,374,782 discloses the production of microspheres of a macromolecule such as protein mixed with a water-soluble polymer under conditions which permit the water-soluble polymer to remove water from the protein in contact with a hydrophobic surface. U.S. Pat. No. 7,297,404 discloses coacervative microencapsulation, which can be followed by phase separation and cross-linking. U.S. Pat. No. 7,375,070 discloses microencapsulated particles with outer walls including water-soluble polymers or polymer mixtures as well as enzymes. U.S. Pat. No. 7,294,678 discloses a polynitrile oxide or a polynitrile oxide dispersion microencapsulated within a barrier material coating prior to compounding it into a rubber mixture to prevent premature reaction with rubber particles. U.S. Pat. No. 7,368,613 discloses microencapsulation using capsule materials made of wax-like plastics materials such as polyvinyl alcohol, polyurethane-like substances, or soft gelatin. U.S. Pat. Nos. 4,889,877; 4,936,916; and 5,741,592 are also related to microencapsulation.

Suitable capsule or shell materials can be or include any one or more of a number of different materials. For example, the capsule or shell material can include natural polymers, synthetic polymers, synthetic elastomers, and the like. Illustrative natural polymers can include, but are not limited to, carboxymethylcellulose, zein, cellulose acetate phthalate, nitrocellulose, ethylcellulose, propylhydroxycellulose, gelatin, shellac, gum Arabic, succinylated gelatin, starch, paraffin waxes, bark, proteins, methylcellulose, kraft lignin, arabinogalactan, natural rubber, or any combination thereof. Illustrative synthetic polymers can include, but are not limited to, polyvinyl alcohol, polyvinyidene chloride, polyethylene, polyvinyl chloride, polypropylene, polyacrylate, polystyrene, polyacrylonitrile, polyacrylamide, chlorinated polyethylene, polyether, acetal copolymer, polyester, polyurethane, polyamide, polyvinylpyrrolidone, polyurea, poly(p-xylylene), epoxy, polymethyl methacrylate, ethylene-vinyl, polyhydroxyethyl, acetate copolymer, methacrylate, polyvinyl acetate, or any combination thereof. Illustrative synthetic elastomers can include, but are not limited to, polybutadiene, acrylonitrile, polyisoprene, nitrile, neoprene, butyl rubber, chloroprene, polysiloxane, styrene-butadiene rubber, hydrin rubber, silicone rubber, ethylene-propylene-diene terpolymers, or any combination thereof.

A plurality of lignocellulose substrates, one or more resins or binder compositions, and one or more hydrophobizing agents can be mixed, blended, stirred, contacted, or otherwise combined with one another to produce a composite mixture or “mixture.” The mixture can also be referred to as a “furnish,” “blended furnish,” “resinated mixture,” and “resinated furnish.” The mixture can be heated to produce a composite lignocellulose product or “composite product.”

In one or more embodiments, a lignocellulose composite product can be made by contacting one or more lignocellulosic substrates with one or more resins or binder compositions and the mixture of the hydrophobic agent and the liquid medium to produce a mixture. The resin or binder composition can be at least partially cured to produce the composite product. The resin can be cured via a number of methods, e.g., with the addition of one or more acids, bases, and/or catalysts, the application of heat, and/or pressure, or any combination thereof, to produce the composite product.

The mixture can be heated to at least partially cure the binder composition contained therein to produce the lignocellulose composite product or simply “composite product.” As used herein, the terms “curing,” “cured,” “at least partially cured,” and similar terms are intended to refer to the structural and/or morphological change that occurs in the mixture, such as by covalent chemical reaction (crosslinking), ionic interaction or clustering, phase transformation or inversion, and/or hydrogen bonding when the mixture is subjected to conditions sufficient, e.g., sufficiently heated, to cause the properties of a flexible, porous substrate, such as a nonwoven mat or blanket of lignocellulose substrates and/or a rigid or semi-rigid substrate, such as wood or other lignocellulose containing board, to which an effective amount of the binder composition has been applied, to be altered.

Various resins, such as thermosetting resins, can be employed in the binder composition. The resin can be a powder phenolic resin, or the resin can be a liquid phenolic or amino based resin. Suitable resins can include, but is not limited to, isocyanate resin, urea-formaldehyde (UP) resin, phenol-formaldehyde (PF) resin, melamine-urea-formaldehyde (MUF) resin, melamine-formaldehyde (MF) resin, or melamine-urea-phenol-formaldehyde (MUPF) resin, and any mixture thereof. The resin can be polymeric diphenylmethane diisocyanate “MDI”. A suitable MDI resin product can be RUBINATE® 1840 available from Huntsman, Salt Lake City, Utah, and MONDUR® 541 MDI available from Bayer Corporation, North America, of Pittsburgh, Pa. Suitable commercial MUF binders are the LS 2358 and LS 2250 products from Dynea Corporation, Helsinki, Finland.

In one or more embodiments, the composite or resinated mixture can be substantially free from any petroleum based hydrophobizing agent. For example, the composite or resinated mixture can contain less than 5 wt %, less than 4 wt %, less than 3.5 wt %, less than 3 wt %, less than 2.5 wt %, less than 2 wt %, less than 1.5 less than, less than 1 wt %, less than 0.7 wt %, less than 0.5 wt %, less than 0.3 wt %, or less than 0.1 wt % of any petroleum based hydrophobizing agent, based on the weight of the composite or the resinated mixture. In one or more embodiments, the composite or resinated mixture can be substantially free from any petroleum based compound. For example, the composite or resinated mixture can contain less than 5 wt %, less than 4 wt %, less than 3.5 wt %, less than 3 wt %, less than 2.5 wt %, less than 2 wt %, less than 1.5 less than, less than 1 wt %, less than 0.7 wt %, less than 0.5 wt %, less than 0.3 wt %, or less than 0.1 wt % of any petroleum based compound, based on the weight of the composite or the resinated mixture. In at least one specific embodiment, the composite or the resinated mixture can be free from any petroleum based hydrophobizing agent. In at least one specific embodiment, the composite or the resinated mixture can be free from any petroleum based compound.

The composite product can have a resin content from a low of about 1 wt %, about 1.5 wt %, about 3.5 wt %, about 5.5 wt %, or about 10 wt % to a high of about 15 wt %, about 17 wt %, or about 25 wt %, based on the dry weight of the composite product. In another example, the composite product can have a resin content of about 1.2 wt % to about 2.4 wt %, about 3.2 wt % to about 4.4 wt %, about 5.2 wt % to about 6.7 wt %, about 10.2 wt % to about 14.6 wt %, about 17 wt % to about 20 wt %, or about 22 wt % to about 24 wt %, based on the dry weight of the composite product.

The mixture can include one or more liquid mediums. The liquid medium can be or include, but is not limited to, water, alcohols, glycols, acetonitrile, dimethyl sulfoxide, N,N-dimethylformamide, N-methylpyrrolidone, or any combination thereof. Suitable alcohols can include, but are not limited to, methanol, ethanol, propanol, isopropanol, butanol, or any combination thereof. Suitable glycols can include, but are not limited to, ethylene glycol, propylene glycol, or a combination thereof. As used herein, the terms “aqueous medium” and “aqueous liquid” can be or include water and/or mixtures composed of water and/or other water-miscible solvents. Illustrative water-miscible solvents can include, but are not limited to, alcohols, ethers, amines, other polar aprotic solvents, and the like.

The mixture can have a liquid medium, e.g., water, content from a low of about 1 wt %, about 3 wt %, about 5 wt %, or about 10 wt % to high of about 12 wt %, about 14 wt %, about 16 wt %, about 18 wt %, about 20 wt %, about 22 wt %, or about 24 wt %, based on the combined weight lignocellulosic substrates, the resin, and the hydrophobizing agent. For example, when the mixture contains water as the liquid, the mixture can have a moisture content of about 2 wt % to about 6 wt %, about 4 wt % to about 8 wt %, about 5 wt % to about 9 wt %, about 7 wt % to about 10 wt %, about 8 wt % to about 12 wt %, about 10 wt % to about 15 wt %, or about 14 wt % to about 20 wt %, based on the combined weight lignocellulosic substrates, the resin, and the hydrophobizing agent.

The pH of the liquid medium can be acidic, neutral, or basic. For example, the pH of the liquid medium can be from a low of about 1, about 3, or about 5 to a high of about 9, about 11, or about 13. In another example, the pH of the liquid medium can be about 3.5 to about 6, about 4.5 to about 6.5, about 6 to about 7, about 7 to about 9, or about 9 to about 11.5. The pH of the mixture can be adjusted to any desired pH by combining one or more base compounds, one or more acid compounds, or a combination of one or more base compounds and one or more acid compounds therewith.

The mixture contacted to the lignocellulosic substrates are referred to herein as a coating, even though the resin and the mixture of the hydrophobizing agent and the liquid medium can be in the form of small particles, such as atomized particles or solid particles, which do not form a continuous coating upon the lignocellulosic substrates. The resin and the mixture of the hydrophobizing agent and the liquid medium can be applied to the lignocellulosic substrates by one or more spraying, blending or mixing techniques. One technique is to spray the binder resin and the mixture of the hydrophobizing agent and the liquid medium on the wood strands as the strands are tumbled in a drum blender. In one example, the mixture of the hydrophobizing agent and the liquid medium can be added through a j-nozzle at a temperature that can be about 60° C. to about 99° C. depending on the melt point of the hydrophobizing agent (e.g., the hydrophobizing agent is added at temperature above its melting point). In one aspect, the loading level of the mixture of the hydrophobizing agent and the liquid medium can be about 0.5 wt % to about 2.5 wt %. In an example, the mixture of the hydrophobizing agent and the liquid medium and the binder resin can be applied sequentially to the lignocellulosic substrates.

Pressure can optionally be applied to the mixture before, during, and/or after the mixture is heated to produce the composite product. For example, if the desired composite product shape or structure is a panel, sheet, board, or the like, an amount of the mixture sufficient to produce a composite product of the desired size, can be transported, directed, placed, introduced, disposed, or otherwise located within a press capable of pressing the mixture before the mixture is heated and/or when the mixture is heated. The press can be an open press or a closed press. In at least one specific embodiment, an open press can be used to press the mixture when the mixture is heated. The mixture can also be extruded through a die (e.g., extrusion process) and heated to produce the composite product. The press temperature can be from a low of about of about 100° C., about 125° C., or about 175° C., to a high of about 275° C., about 300° C., or about 400° C. In another example, the press temperature can be about 160° C. to about 175° C., about 175° C. to about 200° C., about 200° C. to about 225° C., about 220° C. to about 255° C., about 255° C. to about 275° C., or about 275° C. to about 325° C., about 300° C. to about 400° C.

The mixture can be heated to a temperature of at least 60° C., at least 70° C., at least 80° C., at least 90° C., at least 110° C., at least 130° C., at least 155° C., at least 200° C., at least 225° C., at least 250° C., at least 275° C., or at least 300° C. The mixture can be heated to a temperature from a low of 60° C., about 90° C., about 120° C., about 150° C., or about 160° C. to a high of about 170° C., about 200° C., about 230° C., about 360° C., or about 500° C. to produce the composite product. The mixture can be heated to a temperature of about 140° C. to about 200° C., about 155° C. to about 185° C., about 180° C. to about 210° C., about 200° C. to about 250° C., or about 245° C. to about 500° C.

The mixture can be pressed to a pressure from a low of about 0.5 MPa, about 1 MPa, about 3 MPa, or about 5 MPa to a high of about 7 MPa, about 9 MPa, or about 10 MPa. The mixture can be pressed by a pressure of about 0.6 MPa to about 0.9 MPa, about 0.7 MPa to about 1.8 MPa, about 1.9 MPa to about 2.9 MPa, about 3.6 MPa to about 4.8 MPa, about 4.6 MPa to about 5.8 MPa, about 6.2 MPa. In another example, the mixture can be pressed to a pressure of about 0.6 MPa to about 0.9 MPa, about 0.7 MPa to about 1.8 MPa, about 1.9 MPa to about 2.9 MPa, about 3.6 MPa to about 4.8 MPa, about 4.6 MPa to about 5.8 MPa, about 6.2 MPa to about 7.9 MPa, or about 8.6 MPa to about 9.9 MPa.

Lignocellulosic composite products made with the mixture of the hydrophobizing agent and the liquid medium can be used to produce a variety of articles. For example, the composite products can be used as sheathing to form a floor, roof or wall or in furniture, to name a few. Illustrative composite products discussed and described herein can include, but are not limited to, particleboard, fiberboard such as medium density fiberboard (MDF) and/or high density fiberboard (HDF), plywood such as hardwood plywood and/or softwood plywood, oriented strand board (OSB), laminated veneer lumber (LVL), laminated veneer timber, laminated veneer boards (LVB), parallel stranded lumber (PSL), oriented stranded lumber (OSL), engineered wood flooring, and the like. The parallel stranded lumber can be PARALLAM® made by Weyerhaeuser NR Company. The oriented stranded lumber can be TIMBERSTRAND® made by Weyerhaeuser NR Company.

The plurality of layers of wood strands, flakes, chips, particles, or wafers where each layer of wood strands, flakes, chips, particles, or wafers includes strands oriented perpendicularly to the adjacent layers. As used herein, “flakes”, “strands”, “chips”, “particles”, and “wafers” are considered equivalent to one another and are used interchangeably. Such wood strands are bonded together by a binder resin and sized by a sizing agent disclosed herein.

Lignocellulosic substrates can be made from a variety of different lignocellulosic materials, such as wood, including naturally occurring hardwood or softwood species, singularly or mixed, and grasses such as bamboo. Strands of lignocellulosic materials are cut, dried, and then coated with the binder resins, mixture of hydrophobizing agent, and other additives.

As used herein, the term “lignocellulose” refers to a material that includes lignin and cellulose, hemicelluose, or a combination of cellulose and hemicelluloses. The starting material, from which the lignocellulose substrates can be or can be derived from, can be shaped, reduced, or otherwise formed to the appropriate dimensions by various processes such as hogging, grinding, hammer milling, tearing, shredding, and/or flaking. Other processes for producing the substrates can include skiving, cutting, slicing, and/or sawing. The lignocellulose substrates can be scrimber, which is wood that has been soaked, crushed, and pulled apart to make the substrates. Suitable forms of the lignocellulose substrates can include, but are not limited to, chips, flakes, wafers, fibers, powder, shavings, sawdust or dust, veneer, strands, and/or the like. Accordingly, the term “substrate” when used in conjunction with “lignocellulose” refers to lignocellulose material or lignocellulose containing material having any desired shape such as chips, flakes, fibers, powder, shavings, sawdust or dust, veneer, strands, and/or the like. Other suitable lignocellulose substrates can include, but are not limited to, wood chips, wood fibers, wood flakes, wood strands, wood wafers, wood shavings, wood particles, wood veneer, or any combination thereof.

Composite products in the shape or form of a panel, sheet, board, or the like can be in the form of a rectangular prism that includes six outer surfaces, e.g., three pairs of oppositely facing surfaces. The first pair of oppositely facing surfaces of the composite product can include a first or “top” surface and an opposing second or “bottom” surface. The second and third pairs of oppositely facing surfaces of the composite product can be referred to as the “side surfaces” that have a surface area less than the surface area of the first and second surfaces. As such, composite products in the shape or form of a panel, sheet, board, or the like can have an average thickness, where the average thickness is the length or distance between the first and second surfaces.

The heating of the mixture can be determined, at least in part, by the length of the composite product. For example, the composite product is in the form of a panel, sheet, board, or the like, the amount or length of time the mixture can be heated from a low of about 5 seconds per millimeter (s/mm), about 10 s/mm, about 12 s/mm, or about 15 s/mm to a high of about 17 s/mm, about 19 s/mm, about 21 s/mm, about 23 s/mm, about 25 s/mm, about 27 s/mm, about 30 s/mm, about 35 s/mm, about 40 s/mm, about 50 s/mm, or about 60 s/mm, where the length refers to the average thickness of the composite product. For example, the mixture can be heated for about 7 s/mm to about 27 s/mm, about 9 s/mm to about 24 s/mm, about 11 s/mm to about 22 s/mm, about 8 s/mm to about 20 s/mm, about 14 s/mm to about 18 s/mm, about 6 s/mm to about 14 s/mm, about 10 s/mm to about 18 s/mm, or about 10 s/mm to about 16 s/mm, where the length refers to the average thickness of the composite product. In another example, the mixture can be heated for a time less than 22 s/mm, less than 20 s/mm, less than 18 s/mm, less than 17 s/mm, less than 16 s/mm, less than 15 s/mm, less than 14 s/mm, less than 13 s/mm, or less than 12 s/mm, where the length refers to the average thickness of the composite product. In one specific example, a composite product in the form of a panel, sheet, board, or the like and having an average thickness of about 15 mm and subjected to a total heating time of about 4 minutes would correspond to heating the mixture for about 16 s/mm. In another specific example, the mixture can be heated to a temperature of about 160° C. to about 170° C. for a time of 13 s/mm to about 19 s/mm.

The particular configuration of the lignocellulose substrates can be based, at least in part, on the desired product. For example, particulates such as chips, fibers, shavings, sawdust or dust, or the like can be used for producing particleboards, fiberboards, and the like. The lignocellulose substrates can have a length from a low of about 0.05 mm, about 0.1 mm, about 0.2 mm to a high of about 1 mm, about 5 mm, about 10 mm, about 20 mm, about 30 mm, about 40 mm, about 50 mm, or about 100 mm, with suitable ranges including the combination of any two values. In another example, the lignocellulose substrates can be veneers, e.g., layers or sheets of wood, can be used for producing plywood, laminated veneer lumber, and the like. The veneers can have a thickness from a low of about 0.8 mm, about 0.9 mm, about 1 mm, about 1.1 mm or about 1.2 mm to a high of about 3 mm, about 4 mm, about 5 mm, about 6 mm, about 7 mm, about 8 mm, about 9 mm, or about 10 mm, with suitable ranges including the combination of any two values.

The lignocellulose substrates can include liquid on, about, and/or within the substrates. For example, the lignocellulose substrates can have a liquid, e.g., moisture, content from a low of about 1 wt %, about 2 wt %, about 3 wt %, about 4 wt, or about 5 wt % to a high of about 7 wt %, about 9 wt %, about 11 wt %, about 13 wt %, about 15 wt %, about 17 wt %, about 19 wt %, about 21 wt %, about 23 wt %, about 25 wt %, about 27 wt %, about 29 wt %, about 31 wt %, about 33 wt %, about 35 wt %, or about 37 wt %, based on a dry weight of the lignocellulose substrate, with suitable ranges including the combination of any two values. In another example, the lignocellulose substrates can have a liquid, e.g., moisture, content of about 1 wt % to about 10 wt %, about 2 wt % to about 4 wt %, about 2 wt % to about 3 wt %, about 3 wt % to about 6 wt %, about 5 wt % to about 10 wt %, about 6 wt % to about 8 wt %, or about 4 wt % to about 9 wt %. The lignocellulose substrates can be fresh, e.g., not treated or dried, or dried and/or treated. For example, the lignocellulose substrates and/or the starting material from which the lignocellulose substrates were derived can be at least partially dried. In another example, the lignocellulose substrates can be washed and/or leached with an aqueous medium such as water.

The method of making the composite products can include a continuous or semi-continuous blending process in which the lignocellulose substrates and the other components of the mixture can be introduced to a blender at a first or introduction region, end, area, or other location(s) configured to receive the components and the mixture can be withdrawn from the blender via one or more mixture recovery outlets. The blender can be configured to contain anywhere from a few hundred kilograms to several thousand kilograms. For example, in a single blender anywhere from a low of about 500 kg/hr, about 5,000 kg/hr, about 10,000 kg/hr, or about 13,000 kg/hr to a high of about 16,000 kg/hr, about 20,000 kg/hr, about 25,000 kg/hr, or about 30,000 kg/hr of the mixture can be recovered from the blender. As the mixture exits the blender, the mixture can be deposited onto a conveyor belt and can be transported to one or more dryers, moistening systems, presses, and/or other processing equipment. For example, a particle board product can be made by blending a first or “face” mixture and a second or “core” mixture in a first and second blend, respectively. The first blender can produce about 13,600 kg/hr to about 15,900 kg/hr of a “face” mixture and the second blender can produce about 18,100 kg/hr to about 20,400 kg/hr of a “core” mixture. The “face” and “core” mixtures can be used to produce a particleboard panel or sheet, where the “face” mixture makes up the outer layers of the particleboard and the “core” mixture makes up the inner or core layer of the particleboard.

Referring to particleboard in particular, particleboard made according to one or more embodiments discussed and described herein can meet or exceed the requirements for H-1, H-2, H-3, M-0, M-1, M-S, M-2, M-3i, LD-1, and/or LD-2 grade particleboard as described in the American National Standards Institute (ANSI) for particleboard, i.e., ANSI A208.1-2009 Particleboard, approved Feb. 2, 2009. Particleboard made according to one or more embodiments discussed and described herein can meet or exceed the requirements for PBU, D-2, D-3, and/or M-3 as defined by the ANSI for particleboard, i.e., ANSI A208.1-2009 Particleboard, approved Feb. 2, 2009. For example, Tables A and B set out certain requirements for the different grades of particleboard. Referring to oriented strand board (OSB) in particular, OSB made according to one or more embodiments discussed and described herein can meet or exceed the U.S. Department of Commerce Voluntary Performance Standard PS 2. Referring to plywood in particular, plywood made according to one or more embodiments discussed and described herein can meet or exceed the U.S. Department of Commerce Voluntary Performance Standard PS 1 and/or PS-2.

In one or more embodiments, one or more additives can be combined with the lignocellulose substrates. Illustrative additives can include, but are not limited to, waxes and/or other hydrophobic additives, water, filler material(s), extenders, surfactants, release agents, dyes, fire retardants, formaldehyde scavengers, biocides, or any combination thereof. For composite wood products, such as plywood, filler materials) can include, but are not limited to, ground pecan and/or walnut shells, and typical extenders can include, for example, wheat flour. Other suitable extenders can include, but are not limited to, polysaccharides, and the like. Illustrative polysaccharides can include, but are not limited to, starch, cellulose, gums, such as guar and xanthan, alginates, pectin, gellan, or any combination thereof. Suitable polysaccharide starches can include, for example maize or corn, waxy maize, high amylose maize, potato, tapioca, and wheat starch. Other starches such as genetically engineered starches can include high amylose potato and potato amylopectin starches.

If one or more additives are present in the mixture, the amount of each additive can be from a low of about 0.01 wt % to a high of about 50 wt %, based on the total weight of the mixture. For example, the amount of any given component or additive can be from a low of about 0.01 wt %, about 0.05 wt %, about 0.1 wt %, about 0.5 wt %, or about 1 wt % to a high of about 3 wt %, about 5 wt %, about 7 wt %, or about 9 wt %, based on the total weight of the mixture. In another example, the amount of any given additive or component can be from a low of about 1 wt %, about 5 wt %, about 10 wt %, about 15 wt %, or about 20 wt % to a high of about 25 wt %, about 30 wt %, about 35 wt %, about 40 wt %, or about 45 wt %, based on the total weight of the mixture.

The composite product can have a density from a low of about 0.5 g/cm³, about 0.55 g/cm³, about 0.6 g/cm³, about 0.63 g/cm³, about 0.65 g/cm³, about 0.67 g/cm³, or about 0.7 g/cm³ to a high of about 0.75 g/cm³, about 0.77 g/cm³, about 0.8 g/cm³, about 0.83 g/cm³, about 0.85 g/cm³, about 0.88 g/cm³, about 0.93 g/cm³, about 0.97 g/cm³, or about 1 g/cm³. For example, the composite product can have a density of about 0.7 g/cm³ to about 0.75 g/cm³, about 0.65 g/cm³ to about 0.85 g/cm³, about 0.65 g/cm³ to about 0.8 g/cm³, about 0.67 g/cm³ to about 0.77 g/cm³, about 0.5 g/cm³, to about 1 g/cm³, about 0.5 g/cm³, to about 0.8 g/cm³, about 0.5 g/cm³ to about 0.75 g/cm³, or about 0.64 g/cm³ to about 0.8 g/cm³. In one or more embodiments, the composite product can have density less than 1 g/cm³, less than 0.95 g/cm³, less than 0.88 g/cm³, less than 0.85 g/cm³, less than 0.83 g/cm³, less than 0.8 g/cm³, less than 0.79 g/cm³, less than 0.78 g/cm³, less than 0.77 g/cm³, less than 0.76 g/cm³, less than 0.75 g/cm³, less than 0.74 g/cm³, or less than 0.73 g/cm³.

The composite product can have an internal bond strength from a low of about 0.3 MPa, about 0.32 MPa, about 0.34 MPa, about 0.35 MPa, about 0.37 MPa, about 0.4 MPa, about 0.42 MPa, about 0.48 MPa, about 0.52 MPa, about 0.55 MPa, or about 0.58 MPa to a high of about 0.69 MPa, about 0.75 MPa, about 0.83 MPa, about 0.9 MPa, about 0.97 MPa, about 1.05 MPa, about 1.15 MPa, about 1.2 MPa, about 1.25 MPa, about 1.3 MPa, about 1.35 MPa, about 1.4 MPa, about 1.45 MPa, about 1.5 MPa, about 1.55 MPa, about 1.6 MPa, or about 2 MPa, with suitable ranges including the combination of any two values. For example, the composite product can have an internal bond strength of about 0.35 MPa to about 0.55 MPa, about 0.4 MPa to about 0.6 MPa, about 0.48 MPa to about 0.69 MPa, about 0.59 MPa to about 0.86 MPa, about 0.55 MPa to about 0.9 MPa, or about 0.51 MPa to about 0.85 MPa. In one or more embodiments, the composite product can have an internal bond strength of at least 0.33 MPa, at least 0.32 MPa, at least 0.34 MPa, at least 0.38 MPa, at least 0.41 MPa, at least 0.45 MPa, at least 0.48 MPa, at least 0.51 MPa, at least 0.55 MPa, at least 0.58 MPa, at least 0.62 MPa, at least 0.66 MPa, at least 0.69 MPa, at least 0.72 MPa, at least 0.76 MPa, or at least 1.4 MPa. The internal bond strength can be determined according to ASTM D1037-06a.

The composite product can have a thickness swell of at least 2%, at least 5%, at least 8%, or at least 15%. The composite product can have a thickness swell of less than 50%, less than 40%, less than 35%, less than 30%, less than 25%, less than 20%, less than 15%, or less than 10%. The composite product can have a thickness swell from a low of about 0%, about 5%, about 10% to a high of about 30%, about 40%, about 50%. For example the composite product can have a thickness swell of about 3% to about 12%, about 11% to about 16%, about 13% to about 20%, about 19% to about 32%, about 29% to about 42%, or about 35% to about 47%. The thickness swell can be determined according ASTM D1037-06a.

The composite product can have a water absorption of less than 75 wt %, less than 50 wt %, less than 30 wt %, less than 20 wt %, or less than 10 wt %, based on the total weight of the composite product. The composite product can have a water absorption from a low of about 0 wt %, about 15 wt %, about 30 wt % to a high of about 55 wt %, about 65 wt %, about 75 wt %, based on the total weight of the composite product. For example the composite product can have a water absorption of about 3 wt % to about 12 wt %, about 11 wt % to about 16 wt %, about 13 wt % to about 20 wt %, about 19 wt % to about 32 wt %, about 29 wt % to about 42 wt %, or about 35 wt % to about 47 wt %, based on the total weight of the composite product. The water absorption can be determined according to ASTM D1037-06a.

In one or more embodiments, the composite product can have a density less than 1 g/cm³, less than 0.95 g/cm³, less than 0.9 g/cm³, less than 0.85 g/cm³, less than 0.8 g/cm³, less than 0.79 g/cm³, less than 0.78 g/cm³, less than 0.77 g/cm³, less than 0.76 g/cm³, less than 0.75 g/cm³, less than 0.74 g/cm³, or less than 0.73 g/cm³ and an internal bond strength of at least 0.3 MPa, at least 0.35 MPa, at least 0.4 MPa, at least 0.48 MPa, at least 0.51 MPa, at least 0.55 MPa, at least 0.58 MPa, at least 0.62 MPa, at least 0.65 MPa, or at least 0.69 MPa. In at least one specific example, the composite product can have a density less than 0.8 g/cm³ and internal bond strength of at least 0.48 MPa. In at least one other specific example, the composite product can have a density less than 0.8 g/cm³ and internal bond strength of at least 0.69 MPa. In at least one other specific example, the composite product can have a density of less than 0.73 g/cm³ and internal bond strength of at least 0.48 MPa. In still another example, the composite product can have a density of less than 0.73 g/cm³ and internal bond strength of at least 0.58 MPa.

Composite products such as particleboard, fiberboard, plywood, and oriented strand board, can have a thickness or average thickness from a low of about 1.5 mm, about 5 mm, or about 10 mm to a high of about 15 mm, about 20 mm, about 25 mm, about 30 mm, about 50 mm, about 100 mm, about 200 mm, or about 490 mm. Composite products can have a length from a low of about 0.1 m, about 0.5 m, about 1 m, about 1.2 m, to a high of about 2 m, about 2.4 m, about 3 m, or about 3.6 m. The composite products can also have a width from a low of about 0.1 m, about 0.5 m, about 1 m, to a high of about 1.8 m, about 2.4 m, or about 3 m.

The pH of the mixture can be acidic, neutral, or basic. For example, the pH of the mixture can be from a low of about 1, about 2, or about 3 to a high of about 8, about 10, about 11, or about 12.5, with suitable ranges including the combination of any two values. In another example, the pH of the mixture can be about 1 to about 6, about 1.5 to about 5.5, about 2.5 to about 4.5, about 2 to about 3.5, about 2.5 to about 3.5, about 4.5 to about 7 about 7 to about 8, about 7.5 to about 10 about 10 to about 12.5. The pH of the mixture can be adjusted to any desired pH by combining one or more base compounds, one or more acid compounds, or a combination of one or more base compounds and one or more acid compounds therewith.

Illustrative base compounds that can be used to adjust the pH of the mixture can include, but are not limited to, hydroxides, carbonates, ammonia, amines, or any combination thereof. Illustrative hydroxides can include, but are not limited to, sodium hydroxide, potassium hydroxide, ammonium hydroxide (e.g., aqueous ammonia), lithium hydroxide, and cesium hydroxide. Illustrative carbonates can include, but are not limited to, sodium carbonate, sodium bicarbonate, potassium carbonate, and ammonium carbonate. Illustrative amines can include, but are not limited to, trimethylamine, triethylamine, triethanolamine, diisopropylethylamine (Hunig's base), pyridine, 4-dimethylaminopyridine (DMAP), and 1,4-diazabicyclo[2.2.2]octane (DABCO).

Illustrative acid compounds that can be used to adjust the pH of the mixture can include, but are not limited to, one or more mineral acids, one or more organic acids, one or more acid salts, or any combination thereof. Illustrative mineral acids can include, but are not limited to, hydrochloric acid, nitric acid, phosphoric acid, sulfuric acid, or any combination thereof. Illustrative organic acids can include, but are not limited to, acetic acid, formic acid, citric acid, oxalic acid, uric acid, lactic acid, or any combination thereof. Illustrative acid salts can include, but are not limited to, ammonium sulfate, sodium bisulfate, sodium metabisulfite, or any combination thereof. The acid compounds can also include latent acids, which are released upon heating or irradiating. Suitable latent acids can include, but are not limited to, one or more amine salts. Suitable amine salts can be the reaction products of one or more amines with one or more acids.

The catalyst can also be referred to as an initiator, a promoter, a reducer, and/or an accelerator. Suitable catalysts can be or include, but are not limited to, acids, bases, and metal catalysts can be used to at least partially cure the binder. Suitable acids can include, but are not limited to, sulfuric acid, maleic acid, lactic acid, acetic acid, formic acid, a urea/phenolsulfonic acid, toluene sulfonic acid, or any combination thereof. Suitable bases can include, but are not limited, sodium hydroxide, ammonium hydroxide, ammonium sulfate, potassium hydroxide, triethylene tetraamine, diethylene triamine, triethylamine, urea, GP® 4590 k-20 precatalyst, made by Georgia-Pacific Chemicals LLC, or any combination thereof. Suitable metal catalysts can include, but are not limited to, salts of sodium, potassium, aluminum, magnesium, zinc, or any combination thereof. Other suitable catalysts can include, but are not limited to, sodium nitrate, aluminum sulfate, ammonium hydrogen phosphate, ammonium persulfate, ammonium chloride, ammonium nitrate, ammonium sulfate, or any combination thereof. Suitable metal catalysts can also include transition metals, transition metal salts, transition metal complexes, and mixtures thereof.

The amount of acid, base, or metal catalyst, if present, can widely vary. For example, the amount of catalyst in the mixture can be from a low of about 0.00001 wt %, about 0.0001 wt %, about 0.001 wt %, about 0.01 wt %, or about 0.1 wt % to about 0.5 wt %, about 1 wt %, about 3 wt %, about 5 wt %, about 10 wt %, or about 20 wt %, based on the dry weight of the lignocellulose substrates, with suitable ranges including the combination of any two values. In another example, the amount of catalyst in the mixture can be about 0.01 wt % to about 1.5 wt %, about 0.1 wt % to about 1.3 wt %, about 0.05 wt % to about 0.5 wt %, about 0.07 wt % to about 0.4 wt %, about 0.05 wt % to about 5 wt %, based on the dry weight of the lignocellulose substrates. In another example, the amount of the catalyst in the mixture can be about 0.001 wt % to about 0.5 wt %, about 0.15 wt % to about 0.35 wt %, about 0.1 wt % to about 0.4 wt %, about 0.1 wt % to about 2 wt %, about 0.05 wt % to about 3 wt %, about 0.05 wt % to about 0.35 wt %, about 0.1 wt % to about 4.5 wt %, about 0.15 wt % to about 4 wt %, about 0.05 wt % to about 3 wt %, or about 0.01 wt % to about 3.5 wt %, based on the dry weight of the lignocellulose substrates.

The catalyst, if combined with a liquid medium, can have a total concentration of solids of about 0.001 wt % to about 99.9 wt %. Preferably, if the catalyst is combined with a liquid medium, the catalyst and liquid medium mixture can have a concentration of solids from a low of about 0.1 wt %, about 0.5 wt %, about 1 wt %, or about 2 wt % to a high of about 4 wt %, about 5 wt %, about 6 wt %, about 7 wt %, or about 8 wt %, based on the combined weight of the catalyst and the liquid medium, with suitable ranges including the combination of any two values.

The mixtures discussed and described herein can be free or essentially free of formaldehyde for use in the production of the composite products, e.g., wood products such as particleboard and plywood. As used herein, the term “essentially free of formaldehyde” means the mixture does not include or contain any intentionally added formaldehyde or compounds that can decompose, react, or otherwise form formaldehyde. Said another way, the term “essentially free of formaldehyde” means the mixture does not contain formaldehyde or compounds that can form formaldehyde, but may include formaldehyde present as an impurity. Accordingly, depending on the particular multifunctional aldehyde(s) used to produce the mixtures discussed and described herein, the mixture can be referred to as “no added formaldehyde” or “NAF” mixture.

The composite products discussed and described herein can exhibit a low level of formaldehyde emission. A suitable test for determining formaldehyde emission from a composite product can include ASTM D6007-02 and ASTM E1333-10. For example, the composite products can exhibit a formaldehyde emission of zero. In another example, the composite products can exhibit a formaldehyde emission of less than 1 part per million (ppm), less than 0.09 ppm, less than 0.08 ppm, less than 0.07 ppm, less than 0.06 ppm, less than 0.05 ppm, less than 0.04 ppm, less than 0.03 ppm, less than 0.02 ppm, less than 0.01 ppm, or less than 0.005 ppm.

The composite product can meet or exceed the formaldehyde emission standards required by the California Air Resources Board (CARB) Phase 1 (less than 0.1 parts per million “ppm” formaldehyde for particleboard), and Phase 2 (less than 0.09 ppm formaldehyde for particleboard). The composite products discussed and described herein can also meet or exceed the formaldehyde emission standards required by the Japanese JIS/JAS F*** (does not exceed 0.5 mg/L formaldehyde for particleboard), Japanese JIS/JAS F**** (does not exceed 0.3 mg/L formaldehyde for particleboard), European E1, and European E2 standards.

### Examples

In order to provide a better understanding of the foregoing discussion, the following non-limiting examples are offered. Although the examples may be directed to specific embodiments, they are not to be viewed as limiting the invention in any specific respect. All parts, proportions, and percentages are by weight unless otherwise indicated.

Furnish was blended and resin was applied following standard board-making procedures. The non-petroleum hydrophobizing agents were compared with a soap-based slack wax emulsion manufactured by Momentive Specialty Chemicals, or in the case of OSB, with a solid slack wax manufactured by Exxon-Mobile. The non-petroleum hydrophobizing agents were AKD 1865 (AKD solid) available from Kemira Tiancheng Chemicals Co., Ltd and a 16 wt % emulsion (AKD emulsion); NATUREWAX® available from Elevance Renewable Sciences; a 1 to 2 mixture of sodium methylsiliconate to triethoxyoctylsilane (silicone combination); SRA 250 available from 3M, St. Paul, Minn.; SRC 220, available from 3M, St. Paul, Minn.; microencapsulated materials SHP 50 and SHP 60+, available from Dow Corning Corp.; acrylic emulsion available from available from IFS industries; and SASOLWAX® (synthetic wax) available from Sasol Limited of Rosebank, South Africa.

Since the standard slack wax was an emulsion it was marginally compatible with the resin and the AKD emulsion was not compatible with the resin, the hydrophobizing agents were added slowly to the mixing furnish through a hole in the top center of the blender after the resin and catalyst had been added. Blending was continued for an additional five minutes after the addition of the wax emulsion.

### Particleboard Panel Study

Southern Yellow Pine wood furnish (4,718 g, moisture content of about 6 wt %) was added to a ribbon blender. Under mechanical blending, the binder composition, e.g., mixture of GP®406D44 and catalyst, was sprayed into the ribbon blender through an atomizer. The amount of binder composition added to the wood furnish to produce each particleboard sample was about 8 wt %, based on the dry weight of the wood furnish. The wax was then added to the wood furnish with continued blending. After the moisture content of the wood/furnish composition was measured (8 wt %), 4,718 g of the furnish/binder mix was homogeneously spread into and about 46.4 cm (about 18.25 in.) by about 71.8 cm (about 28.25 in.) mat forming frame and manually pre-pressed. The frame was removed to provide a pre-pressed or consolidated mat. The consolidated mat was placed into a hot press at a temperature of about 166° C. (about 330° F.) and subjected to pressure for about 240 seconds. A three-step pressing program was used for the particleboard production. In a first step, the pressure reached about 4.14 MPa (about 600 psi) after about 60 seconds to a final panel thickness of about 15.7 mm (about 0.620 in.). In a second step, the thickness was held constant at about 15.7 mm (about 0.620 in.) while the pressure was allowed to decrease for the remainder of the pressing cycle. In a third step, a 30 second decompression time at a set thickness of about 16.1 mm (about 0.635 in.) was used at the end of the process.

The particleboard was then cut into 8 blocks measuring about 15.2 cm (about 6 in.) by about 15.2 cm (about 6 in.) with a varying degree of thickness depending on the degree each was compacted in the press. The weights were measured to determine the average density. Water absorption and thickness swell was determined according to ASTM D1037-06a.

Additional panels were prepared, using a smaller about 30.5 cm (about 12 in.) by 30.5 cm (about 12 in.) forming box, to prepare samples which were then cut into about 5.08 cm (about 2 in.) by about 5.08 cm (about 2 in.) blocks. The average density of the blocks were measured according to ASTM D1037-06a. For all particleboard studies, two panels were made and tested with the reported properties representing the average of the two panels. The panels were prepared and pressed following standard procedures. The blending and pressing parameters are shown in Table 1.

TABLE 1

| | |
|---|---|
| Furnish | Southern Yellow Pine from |
| | Sierra Pine, Adel, GA |
| Press Temperature | 166° C. |
| Press Cycle | 240 seconds |
| Density | 0.77 g/cm³ (about 48 lb/ft³) |
| Thickness (in) | 0.625 |
| Resin | GP ® 406D44 |
| Face Resin Loading (% resin | 8 |
| solids on OD Wood) | |
| Wax (wt %) | 0.5 and 1.5% |
| Core Scavenger Urea (wt % | 0 |
| based on resin solids) | |
| Core Ammonium Sulfate | 1 |
| (wt % based on resin solids) | |

Two panels were pressed from each blender load. A 30.5 cm (about 12 in.) by 30.5 cm (about 12 in.) panel to be used for internal bond strength testing and a 45.7 cm (about 18 in.) by 71.1 cm (about 28 in.) panel for water absorption and thickness swell testing were prepared. Density, internal bond (IB) strength, twenty-four hour percent water absorption, and thickness swell of the panels were all measured to determine the impact of the hydrophobizing agent on the strength of the panel. The results are show in Table 2 below.

TABLE 2

| | | | Avg. % | Avg. % |
|---|---|---|---|---|
| | Density | Average | Water | Thickness |
| Treatment | (g/cm³) | IB (MPa) | Absorption | Swell |
| No Wax | 0.79 | 0.85 | 66.3 | 19.6 |
| Slack Wax | 0.84 | 1.01 | 55.1 | 19.9 |
| AKD Emulsion | 0.82 | 1.28 | 58.4 | 16.8 |
| SRA 250 | 0.83 | 1.15 | 59.7 | 18.6 |
| SRC 220 | 0.82 | 1.36 | 62 | 19.6 |
| NATUREWAX ® | 0.83 | 0.94 | 62.8 | 22 |
| Silicone | 0.81 | 1.03 | 59.9 | 18.5 |
| combination | | | | |
| AKD Solid | 0.78 | 1.09 | 63.7 | 17.7 |

The AKD emulsion, SRC 220, and SRA 250 had statistically significantly higher internal bond strengths than the other hydrophobizing agents. GPO 406D44 binder composition was designed to be a tacky resin. The addition of the slack wax emulsion, NATUREWAX® or AKD solid reduced the tack of the resin to the point where, during felting, furnish would not stick to itself. The samples with no wax and with the other alternative hydrophobizing agents were all tacky. Mechanical means was necessary to spread furnish in an even layer in the deckle box by breaking the lumps formed when handling the furnish.

The effect of the hydrophobizing agents on internal bond strength and on tack was of interest. The AKD emulsion sample showed an increase in the internal bond strength over the non-sized samples of nearly 35% and an increase in the internal bond strength of about 20% over the slack wax emulsion sample. The SRA 220 sample showed an increase over the non-sized sample close to about 40% and about 26% over the wax sample. Both the AKD emulsion and the SRA 220 sample also imparted a higher tack and a wetter feel to the furnish. A combination of slack wax and silicone combination, the AKD emulsion, and the SRC-220 offers good short-term and long-term sizing with improved tack and IB strength.

The twenty-four hour percent water absorption results of all samples were statistically equivalent to each other.

The percent thickness swell results showed that, of the alternatives to wax, panels made with the AKD emulsion had the least swell and NATUREWAX® the most swell. The AKD emulsion and SRC 250 performed comparably to the slack wax emulsion, in water absorption and thickness swell testing in 24 hour testing at the lower loading levels used. The other samples were statistically equivalent.

If density was included as a covariant, the results of the water absorption were modified. More particularly, the slack wax emulsion, the AKD emulsion, SRA 250 and the silicone combination showed statistically significantly less water absorption than other samples when density was included as a covariant.

The water absorption of all samples after 24 hours were statistically equivalent as measured by Tukey Post-Hoc Testing, which was chosen for its tendency to reject a statistical difference rather than show a non-difference to be statistically significant when it is not. The four best performing of the samples, on average, were the slack wax, the silicone combination, the AKD emulsion, and SRA 250. The AKD emulsion, the silicone and SRA 250 performed statistically equivalently in the next grouping of samples. The remaining samples, except for no-wax, are statistically equivalent. No wax added had the greatest average water absorption.

The thickness swell measurements showed statistically significantly thicker panels for the no-wax, slack wax, and AKD solid samples, as shown in Table 2. The twenty-four hour thickness swell measurements indicated that the AKD emulsion was, on average, the best performer. Six of the remaining samples were statistically equivalent. NATUREWAX® was statistically the worst performer. Using density as a covariant did not significantly change the results of the analysis.

### OSB Panel Study

Southern Yellow Pine flakes (6,000 g oven dry weight, moisture contents of about 2 wt % to about 8 wt %) was added to rotary blending equipped with application nozzles for loading liquids. The binder resin (240 g based on oven dry wood) and wax or non-petroleum based wax was sprayed onto the tumbling furnish through the nozzles. After completion of the additions, the moisture content of the flakes was measured (of about 4 wt % to about 10 wt %). The resinated furnish (1,395 g on an oven dry basis) was homogeneously spread into a 40.6 cm (about 16 in.) by 40.6 cm (about 16 in.) forming box and then was manually prepressed. The forming frame was removed to provide a pre-pressed, consolidated mat. The consolidated mat was placed into a hot press at a temperature of 210° C. (410° F.) and subjected to pressure for 4 to 5 minutes. Full pressure 0.65 MPa (about 95 psi) was achieved within about 30 seconds. Position was maintained for the remainder of the pressing cycle. At the end of the time, a 30 second decompression time set the thickness at 1.11 cm (about 0.4375 in.). All samples for this testing were made following this general procedure. The blending and pressing parameters are shown in Table 3.

TABLE 3

| | |
|---|---|
| Furnish | Southern Yellow |
| | Pine |
| Press Temperature | 210° C. |
| Press Cycle | 240 to 300 seconds |
| Density | 0.67 g/cm³ |
| Thickness (in) | 0.4375 |
| Resin | GP ®155C42 |
| Face Resin Loading (% resin | 4 |
| solids on OD Wood) | |
| Wax (wt %) | 1.0 and 2.0% |

The density, internal bond (TB) strength, average water absorption, and average thickness swell were measured for each panel to determine the impact the hydrophobizing agent had on the composite products. The results are show in Table 4.

TABLE 4

| | | | Avg. % | Avg. % |
|---|---|---|---|---|
| | Density | Average IB | Water | Thickness |
| Treatment | (g/cm³) | (MPa) | Absorption | Swell |
| No Wax | 0.67 | 0.63 | 80 | 25 |
| 1% Slack Wax | 0.65 | 0.61 | 27 | 15 |
| 2% Slack Wax | 0.65 | 0.70 | 24 | 13 |
| 1% AKD Emulsion | 0.69 | 0.79 | 77 | 24 |
| 2% AKD Emulsion | 0.71 | 0.48 | 75 | 31 |
| 1% SRC 220 | 0.69 | 0.78 | 74 | 25 |
| 2% SRC 220 | 0.65 | 0.65 | 82 | 27 |
| 1% Acrylic Emulsion | 0.66 | 0.66 | 77 | 21 |
| 2% Acrylic Emulsion | 0.68 | 0.64 | 78 | 25 |
| 1% Synthetic Wax | 0.65 | 0.51 | 31 | 13 |
| 2% Synthetic Wax | 0.66 | 0.48 | 27 | 11 |
| 1% SHP 60+ | 0.67 | 0.40 | 105 | 47 |
| 2% SHP 60+ | 0.62 | 0.32 | 108 | 51 |
| 1% SHP 50 | 0.63 | 0.34 | 111 | 49 |

Embodiments of the present disclosure further relate to any one or more of the following paragraphs:

1. A method for making a composite product, comprising: contacting a plurality of lignocellulosic substrates with a resin and a hydrophobizing agent to form a mixture, wherein the hydrophobizing agent comprises one or more vegetable waxes, one or more alkaline metal alkylsiliconates, one or more alkyl ketene dimers, one or more organosilanes, one or polysiloxanes, one or more Fischer-Tropsch waxes, one or more fluorinated polyurethanes, one or more fluorinated acrylate polymers, one or more olefin metathesis products, or any mixture thereof; and at least partially curing the mixture to produce a composite product.

2. A method for making a composite product, comprising: contacting a plurality of lignocellulosic substrates with a resin and a hydrophobizing agent to form a mixture, wherein the hydrophobizing agent comprises a hydrogenated metathesis product; and at least partially curing the mixture to produce a composite product.

3. The method according to paragraph 2, wherein the hydrogenated metathesis product is prepared by metathesizing a triacylglyceride.

4. The method according to paragraph 2, wherein the metathesis product is prepared by metathesizing a vegetable oil.

5. The method according to paragraph 4, wherein the vegetable oil is soybean oil.

6. The method according to paragraph 2, wherein the hydrogenated metathesis product is a polyol ester.

7. The method according to paragraph 2, wherein the hydrogenated metathesis product is a wax.

8. The method according to paragraph 2, wherein the metathesis product is prepared by a metathesis reaction comprising self-metathesis, cross-metathesis, ring-opening metathesis, ring-opening metathesis polymerizations, ring-closing metathesis, or acyclic diene metathesis.

9. A method for making a composite product, comprising: contacting a plurality of lignocellulosic substrates with a resin and a hydrophobizing agent to form a mixture, wherein the hydrophobizing agent is one or more alkaline metal alkylsiliconates; and at least partially curing the mixture to produce a composite product.

10. The method according to paragraph 9, wherein the one or more alkaline metal alkylsiliconates comprises sodium methylsiliconate, sodium ethylsiliconate, sodium propylsiliconate, potassium methylsiliconate, potassium ethylsiliconate, potassium propylsiliconate, or any mixture thereof.

11. A method for making a composite product, comprising: contacting a plurality of lignocellulosic substrates with a resin and a hydrophobizing agent to form a mixture, wherein the hydrophobizing agent is one or more polysiloxanes; and at least partially curing the mixture to produce a composite product.

12. The method according to paragraph 11, wherein the one or more polysiloxanes has the formula:

[chemical structure]

wherein R¹ and R² are independently hydroxyl radicals, C₁-alkoxy to C₄-alkoxy radicals that can be saturated or unsaturated and linear or branched; C₁-hydrocarbon to C₆-hydrocarbon radicals that can be saturated or unsaturated and linear or branched; and n is 1 to about 6,000.

13. A method for making a composite product, comprising: contacting a plurality of lignocellulosic substrates with a resin and a hydrophobizing agent to form a resinated mixture, wherein the hydrophobizing agent has the formula:

[chemical structure]

wherein R¹ and R² are independently a C₈- to C₃₀-hydrocarbon radical, wherein each C₈- to C₃₀-hydrocarbon radical is saturated or unsaturated, and wherein each C₈- to C₃₀-hydrocarbon radical is linear or branched; and at least partially curing the resinated mixture to produce a composite product.

14. The method according to paragraph 13, wherein R¹ and R² are independently selected from the group consisting of: an octyl radical, a decyl radical, a dodecyl radical, a tetradecyl radical, a hexadecyl radical, an octadecyl radical, an eicosyl radical, a docosyl radical, a tetracosyl radical, a phenyl radical, a benzyl radical, a β-naphthyl radical, and a cyclohexyl radical.

15. A method for making a composite product, comprising: contacting a plurality of lignocellulosic substrates with a resin and a hydrophobizing agent to form a resinated mixture, wherein the hydrophobizing agent has the formula:

[chemical structure]

wherein R¹, R², R³, and R⁴ are independently selected from a hydroxyl radical, a C₁ to C₈ alkoxy radicals, a C₁ to C₈ hydrocarbon radical; and at least partially curing the resinated mixture to produce a composite product.

16. The method according to paragraph 15, wherein R¹ and R² are independently selected from the group consisting of: hydrogen, methyl, ethyl, and propyl radical.

17. A method for making a composite product, comprising: contacting a plurality of lignocellulosic substrates with a resin and a hydrophobizing agent to form a resinated mixture, wherein the hydrophobizing agent has the formula:

[chemical structure]

wherein M^{f}ₘM^{h}ₗ is a fluorochemical spacer oligomer comprising m units derived from a fluorochemical spacer monomer and l units derived from a polymerizable monomer, wherein the fluorochemical monomers and the polymerizable spacer monomers are the same or different; m is a number from 2 to 40; l is a number from 0 to 20; T is an organic linking group obtained by removing a hydrogen atom from a chain transfer agent, and the T residues are the same or different; Z is the residue obtained by removing a hydrogen atom from an organic masking or blocking group, and the Z residues are the same or different; A is a di-, tri-, or tetravalent residue obtained by removing 2, 3, or 4 —NCO groups from a corresponding isocyanate, and the A residues are the same or may be different; B is a divalent organic residue obtained by removing the two X—H groups from a difunctional active hydrogen compound HX—B—XH, wherein X is O, NH, or S, and the B residues are the same or different; a is a number from 1 to 3, and b is a number from 0 to 2 with the proviso that a+b has a value from 1 to 3; c is a number from 0 to 30; d and e are numbers from 0 to 2 with the proviso that d+e is not greater than 2; and, wherein M^{f} is a fluorochemical spacer monomer represented by the following formula:

CₙF₂ₙ₊₁—X′—OC(O)NH-A″-HNC(O)O—(CₚH₂ₚ)(O)COC(R′)═CH₂

wherein n is 4; X′ is

[chemical structure]

m is 2 to 4; A″ is

[chemical structure]

R′ is H, CH₃, or F; and p is 2; and at least partially curing the resinated mixture produce a composite product.

18. A method for making a composite product, comprising: contacting a plurality of lignocellulosic substrates with a resin and a hydrophobizing agent to form a resinated mixture, wherein the hydrophobizing agent has the formula:

[chemical structure]

wherein M^{f}ₘM^{h}ₗ is a fluorochemical spacer oligomer, comprising m units derived from a fluorochemical spacer monomer and l units derived from a polymerizable monomer, wherein the fluorochemical monomers and polymerizable spacer monomers are the same or different; m is a number from 2 to 40, inclusive; l is a number from 0 to 20, inclusive; T is an organic linking group obtained by removing a hydrogen atom from a chain transfer agent, and the T residues are the same or different; Z is the residue obtained by removing a hydrogen atom from an organic masking or blocking group, and the Z residues are the same or different; A is a di-, tri-, or tetravalent residue obtained by removing 2, 3, or 4 —NCO groups from a corresponding isocyanate, and the A residues are the same or different; B is a divalent organic residue obtained by removing the two X—H groups from a difunctional active hydrogen compound HX—B—XH, wherein X is 0, NH, or S, and the B residues are the same or different; a is a number from 1 to 3, inclusive, and b is a number from 0 to 2, inclusive, with the proviso that a+b has a value from 1 to 3, inclusive; c is a number from 0 to 30 inclusive; d and e are numbers from 0 to 2, inclusive, with the proviso that d+e is not greater than 2; and, wherein M^{h} is selected from the group consisting of octadecylacrylate, octadecylmethacrylate, 1,4-butanediol diacrylate, polyurethane diacrylates, polyethylene glycol diacrylates, polypropylene glycol diacrylates, laurylmethacrylate, butylacrylate, N-methylol acrylamide, isobutylmethacrylate, ethylhexyl acrylate, ethylhexyl methacrylate, vinylchloride and vinylidene chloride; and at least partially curing the resinated mixture to produce a composite product.

19. A method for making a composite product, comprising: contacting a plurality of lignocellulosic substrates with a resin and a hydrophobizing agent to form a resinated mixture, wherein the hydrophobizing agent is represented by a formula:

[chemical structure]

wherein: -M^{f}ₘM^{h}ₗ is a fluorochemical spacer oligomer comprising m units derived from a fluorochemical spacer monomer, M^{f}, and l units derived from one or more other polymerizable monomers, wherein M^{h} is fluorinated or fluorine-free, wherein the fluorochemical spacer monomers and polymerizable monomers are the same or different; m is a number from 2 to 40, inclusive; l is a number from 0 to 20, inclusive; T is an organic linking group obtained by removing a hydrogen atom from a chain transfer agent, and the T residues are the same or different; Z is a residue obtained by removing a hydrogen atom from an isocyanate-reactive group or blocking group, and the Z residues are the same or different; A is a di- tri- or tetravalent residue obtained by removing 2, 3, or 4 —NCO groups from a corresponding isocyanate; a is a number from 1 to 4, inclusive, and b is a number from 0 to 3, inclusive, with the proviso that a+b has a value from 2 to 4; and, wherein M^{f} is a fluorochemical spacer monomer represented by the following formula:

CₙF₂ₙ₊₁—X′—OC(O)NH-A″—HNC(O)O—(CₚH₂ₚ)(O)COC(R′)═CH₂

where n is 1 to 4; X′ is

[chemical structure]

m is 2 to 4; A″ is

[chemical structure]

R′ is H, CH₃, or F; and p is 2; and at least partially curing the resinated mixture produce a composite product.

20. A method for making a composite product, comprising: contacting a plurality of lignocellulosic substrates with a resin and a hydrophobizing agent to form a resinated mixture, wherein the hydrophobizing agent has the formula:

[chemical structure]

wherein: -M^{f}ₘM^{h}ₗ is a fluorochemical spacer oligomer, comprising m units derived from a fluorochemical spacer monomer, M^{f}, and l units derived from one or more other polymerizable monomers, M^{h}, that is fluorinated or fluorine-free, wherein the fluorochemical spacer monomers and polymerizable monomers are the same or different; m is a number from 2 to 40, inclusive; l is a number from 0 to 20, inclusive; T is an organic linking group obtained by removing a hydrogen atom from a chain transfer agent, and the T residues are the same or different; Z is a residue obtained by removing a hydrogen atom from an isocyanate-reactive group or blocking group, and the Z residues are the same or different; A is a di- tri- or tetravalent residue obtained by removing 2, 3, or 4 —NCO groups from a corresponding isocyanate; a is a number from 1 to 4, inclusive, and b is a number from 0 to 3, inclusive, with the proviso that a+b has a value from 2 to 4; and, wherein M^{h} is selected from the group consisting of octadecylacrylate, octadecylmethacrylate, 1,4-butanediol diacrylate, polyurethane diacrylates, polyethylene glycol diacrylates, polypropylene glycol diacrylates, laurylmethacrylate, butylacrylate, N-methylol acrylamide, isobutylmethacrylate, ethylhexyl acrylate, ethylhexyl methacrylate, vinylchloride and vinylidene chloride; and at least partially curing the resinated mixture to produce a composite product.

21. The method according to any one of paragraphs 1 to 2, wherein the hydrophobizing agent is derived from a non-petroleum based source.

22. The method according to any one of paragraphs 1 to 20, wherein the hydrophobizing agent is a non-petroleum based hydrophobizing agent.

23. The method according to any one of paragraphs 1 to 22, wherein the composite product has an internal bond strength of about 20 psi to about 250 psi.

24. The method according to any one of paragraphs 1 to 23, wherein the composite product has an internal bond strength of about 100 psi to about 200 psi.

25. The method according to any one of paragraphs 1 to 24, wherein the composite product has a water absorption of about 0% to about 80%, as measured according to ASTM D1037-06a.

26. The method according to any one of paragraphs 1 to 25, wherein the composite product has thickness swell of about 0% to about 50%, as measured according to ASTM D1037-06a.

27. The method according to any one of paragraphs 1 to 26, wherein the composite product comprises plywood, particleboard, medium density fiberboard, high density fiberboard, hardwood plywood, softwood plywood, oriented strand board, laminated veneer lumber, laminated veneer timber, laminated veneer boards, parallel stranded lumber, or oriented stranded lumber.

28. The method according to any one of paragraphs 1 to 27, wherein the resin comprises an isocyanate resin, a urea-formaldehyde resin, a phenol-formaldehyde resin, a melamine-urea-formaldehyde resin, a melamine-formaldehyde resin, a melamine-urea-phenol-formaldehyde resin, or any mixture thereof.

29. A resinated furnish, comprising: a plurality of lignocellulosic substrates; one or more resins; and a hydrophobizing agent to form a resinated mixture, wherein the hydrophobizing agent comprises one or more vegetable waxes, one or more alkaline metal alkylsiliconates, one or more alkyl ketene dimers, one or more organosilanes, one or polysiloxanes, one or more Fischer-Tropsch waxes, one or more fluorinated polyurethanes, one or more fluorinated acrylate polymers, one or more olefin metathesis products, or any mixture thereof.

30. The resinated furnish according to paragraph 29, wherein the hydrophobizing agent is made from one or more compounds that are not recovered from petroleum.

31. The resinated furnish according to paragraph 29, wherein the hydrophobizing agent is a non-petroleum based hydrophobizing agent.

32. The method according to paragraph 29, wherein the resin comprises an isocyanate resin, a urea-formaldehyde resin, a phenol-formaldehyde resin, a melamine-urea-formaldehyde resin, a melamine-formaldehyde resin, a melamine-urea-phenol-formaldehyde resin, or any mixture thereof.

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention may be devised without departing from the basic scope thereof, and the scope thereof is determined by the claims that follow.

What is claimed is:

1. A method for making a composite product, comprising:
contacting a plurality of lignocellulosic substrates with a resin and a hydrophobizing agent to form a mixture, wherein the hydrophobizing agent comprises one or more vegetable waxes, one or more alkaline metal alkylsiliconates, one or more alkyl ketene dimers, one or more organosilanes, one or polysiloxanes, one or more Fischer-Tropsch waxes, one or more fluorinated polyurethanes, one or more fluorinated acrylate polymers, one or more olefin metathesis products, or any mixture thereof; and
at least partially curing the mixture to produce a composite product.

2. The method of claim 1, wherein the composite product does not contain any hydrophobizing agent recovered from petroleum or derived from petroleum.

3. The method of claim 1, wherein the hydrophobizing agent is a non-petroleum based hydrophobizing agent.

4. The method of claim 1, wherein the composite product has an internal bond strength of about 0.2 MPa to about 1.7 MPa.

5. The method of claim 1, wherein the composite product has a water absorption of about 10% to about 80%, as measured according to ASTM D1037-06a.

6. The method of claim 1, wherein the composite product has thickness swell of about 0% to about 50%, as measured according to ASTM D1037-06a.

7. The method of claim 1, wherein the composite product comprises plywood, particleboard, medium density fiberboard, high density fiberboard, hardwood plywood, softwood plywood, oriented strand board, laminated veneer lumber, laminated veneer timber, laminated veneer boards, parallel stranded lumber, or oriented stranded lumber.

8. The method of claim 1, wherein the resin comprises an isocyanate resin, a urea-formaldehyde resin, a phenol-formaldehyde resin, a melamine-urea-formaldehyde resin, a melamine-formaldehyde resin, a melamine-urea-phenol-formaldehyde resin, or any mixture thereof.

9. The method of claim 1, wherein:
the composite product has an internal bond strength of about 0.5 MPa to about 1.7 MPa,
the composite product has a water absorption of about 10% to about 80%, as measured according to ASTM D1037-06a,
the composite product has a thickness swell less than 35%, as measured according to ASTM D1037-06a,
the hydrophobizing agent is a non-petroleum based hydrophobizing agent, and
the resin comprises an isocyanate resin, a urea-formaldehyde resin, a phenol-formaldehyde resin, a melamine-urea-formaldehyde resin, a melamine-formaldehyde resin, a melamine-urea-phenol-formaldehyde resin, or any mixture thereof.

10. A resinated furnish, comprising:
a plurality of lignocellulosic substrates;
a resin; and
a hydrophobizing agent, wherein the hydrophobizing agent comprises one or more vegetable waxes, one or more alkaline metal alkylsiliconates, one or more alkyl ketene dimers, one or more organosilanes, one or polysiloxanes, one or more Fischer-Tropsch waxes, one or more fluorinated polyurethanes, one or more fluorinated acrylate polymers, one or more olefin metathesis products, or any mixture thereof.

11. The resinated furnish of claim 10, wherein the hydrophobizing agent is derived from a non-petroleum based source.

12. The resinated furnish of claim 10, wherein the hydrophobizing agent is a non-petroleum based hydrophobizing agent.

13. The method of claim 10, wherein the resin comprises an isocyanate resin, a urea-formaldehyde resin, a phenol-formaldehyde resin, a melamine-urea-formaldehyde resin, a melamine-formaldehyde resin, a melamine-urea-phenol-formaldehyde resin, or any mixture thereof.

14. A method for making a composite product, comprising:
contacting a plurality of lignocellulosic substrates with a resin and a hydrophobizing agent to form a mixture, wherein the hydrophobizing agent comprises a hydrogenated metathesis product; and
at least partially curing the mixture to produce a composite product.

15. The method of claim 14, wherein the hydrogenated metathesis product is prepared by metathesizing a triacylglyceride.

16. The method of claim 14, wherein the metathesis product is prepared by metathesizing a vegetable oil.

17. The method of claim 16, wherein the vegetable oil is soybean oil.

18. The method of claim 14, wherein the hydrogenated metathesis product is a polyol ester.

19. The method of claim 14, wherein the hydrogenated metathesis product is a wax.

20. The method of claim 14, wherein the composite product comprises plywood, particleboard, medium density fiberboard, high density fiberboard, hardwood plywood, softwood plywood, oriented strand board, laminated veneer lumber, laminated veneer timber, laminated veneer boards, parallel stranded lumber, or oriented stranded lumber.
